(19) United States
(12) Patent Application Publication
(10) Pub. No.: US 2025/0128515 A1
(43) Pub. Date: Apr. 24, 2025

(54) LIQUID DISCHARGE APPARATUS

(71) Applicants: Takeyuki KOBAYASHI, KANAGAWA (JP); Isamu KUBO, KANAGAWA (JP)

(72) Inventors: Takeyuki KOBAYASHI, KANAGAWA (JP); Isamu KUBO, KANAGAWA (JP)

(21) Appl. No.: 18/922,402

(22) Filed: Oct. 22, 2024

(30) Foreign Application Priority Data
Oct. 24, 2023 (JP) 2023-182649
Jul. 10, 2024 (JP) 2024-111114

(51) Int. Cl. B41J 2/165

(52) U.S. Cl. CPC B41J 2/16538; B41J 2/16552

(57) ABSTRACT

A liquid discharge apparatus includes a liquid discharge head configured to discharge a liquid; a wiper to wipe a nozzle surface of the liquid discharge head in a wiping direction; a slider to move relative to the wiper to slide along a surface of the wiper in a sliding direction; an applicator having a discharge port to apply a cleaning solution to the wiper; and a circuitry configured to control the wiper, slider, and the applicator to selectively perform one of a first operation and a second operation, wherein, in the first operation, the circuitry is further configured to: control the applicator to apply the cleaning solution to the wiper from the discharge port; and control the slider to slide along the surface of the wiper on which the cleaning solution has been applied by the applicator in the sliding direction.

### CROSS-REFERENCE TO RELATED APPLICATIONS

This patent application is based on and claims priority pursuant to 35 U.S.C. § 119(a) to Japanese Patent Application No. 2023-182649, filed on Oct. 24, 2023, in the Japan Patent Office, and Japanese Patent Application No. 2024-111114, filed on Jul. 10, 2024, in the Japan Patent Office the entire disclosure of which is hereby incorporated by reference herein.

### BACKGROUND

### Technical Field

The present embodiment relates to a liquid discharge apparatus.

### Related Art

An inkjet recording apparatus as a liquid discharge apparatus includes a carriage that moves in a main-scanning direction, and the carriage is mounted with a recording head that can discharge ink from a nozzle surface. If unnecessary ink (residual ink) is attached to the nozzle surface, a meniscus (liquid bridge) of the nozzle surface may collapse.

### SUMMARY

In an aspect of the present disclosure, a liquid discharge apparatus is provided that includes: a liquid discharge head configured to discharge a liquid; a wiper to wipe a nozzle surface of the liquid discharge head in a wiping direction; a slider to move relative to the wiper to slide along a surface of the wiper in a sliding direction; an applicator having a discharge port to apply a cleaning solution to the wiper; and circuitry configured to control the wiper, slider, and the applicator to selectively perform one of a first operation and a second operation, wherein, in the first operation, the circuitry is further configured to: control the applicator to apply the cleaning solution to the wiper from the discharge port; and control the slider to slide along the surface of the wiper on which the cleaning solution has been applied by the applicator in the sliding direction; and in the second operation, the circuitry is further configured to: control the applicator to apply the cleaning solution to the wiper from the discharge port; and controls the wiper, on which the cleaning solution has been applied by the applicator, to wipe the nozzle surface of the liquid discharge head in the wiping direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1A is an explanatory view of an overall configuration of an inkjet recording apparatus according to the present embodiment as viewed from a side;

FIG. 1B is an explanatory view of a main part of the inkjet recording apparatus as viewed from above;

FIG. 1C is a perspective view illustrating a part of a maintenance recovery mechanism provided in the inkjet recording apparatus;

FIG. 2A is a plan view illustrating a part of the maintenance recovery mechanism;

FIG. 2B is a schematic diagram illustrating an outline of a drive mechanism of the maintenance recovery mechanism;

FIG. 3 is a schematic diagram illustrating an outline of a supply and ejection mechanism for a cleaning solution in a maintenance recovery mechanism according to a second embodiment;

FIG. 4 is a schematic diagram illustrating a supply and discharge mechanism for a cleaning solution according to the first embodiment;

FIG. 5 is an explanatory diagram illustrating an elevator of a wiper;

FIG. 6A is a flowchart illustrating a cleaning sequence (first embodiment) of normal cleaning;

FIG. 6B is a flowchart illustrating a cleaning sequence (second embodiment) of normal cleaning;

FIG. 7 is an explanatory diagram illustrating from discharge of a cleaning solution to wiping of a head nozzle surface;

FIG. 8 is an explanatory diagram illustrating from discharge of a cleaning solution to wiping of the head nozzle surface;

FIG. 9A is a diagram illustrating a state where a cleaning solution is discharged through a through hole of a slider;

FIG. 9B-a is a front view, and 9B-b is a cross-sectional view, of the slider;

FIG. 9C-a is a front view, and 9C-b is a cross-sectional view, of a modified example of the slider;

FIG. 10 is a diagram illustrating a cleaning solution discharge state for the wiper;

FIGS. 11A and 11B are diagrams illustrating a state where a cleaning solution applied to the wiper is uniformized by the slider;

FIGS. 12A to 12D are views illustrating a wiped state of the head nozzle surface by the wiper, in which FIG. 12A is a view before wiping, FIG. 12B is a view during wiping, FIG. 12C is a view immediately before an end of wiping, and FIG. 12D is a view at the end of wiping;

FIG. 13A is a maintenance flowchart of the head nozzle surface;

FIG. 13B is a maintenance flowchart of the head nozzle surface;

FIG. 14A is a maintenance flowchart of the head nozzle surface;

FIG. 14B is a maintenance flowchart of the head nozzle surface;

FIG. 15A is a maintenance flowchart of the head nozzle surface;

FIG. 15B is a maintenance flowchart of the head nozzle surface;

FIGS. 16A and 16B are explanatory diagrams of a recording head using cleaning solutions having different thickening properties;

FIG. 17 is a maintenance flowchart of the head nozzle surface;

FIG. 18 is an explanatory diagram of wiper cleaner that discharges a cleaning solution to a wiper contact point;

FIG. 19 is a block configuration diagram of the inkjet recording apparatus;

FIG. 20 is an explanatory side view of a main part, illustrating an example of the liquid discharge apparatus;

FIG. 21 is an explanatory plan view of a main part, illustrating another example of the liquid discharge apparatus; and

FIG. 22 is an explanatory front view illustrating still another example of the liquid discharge apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### Liquid Discharge Apparatus

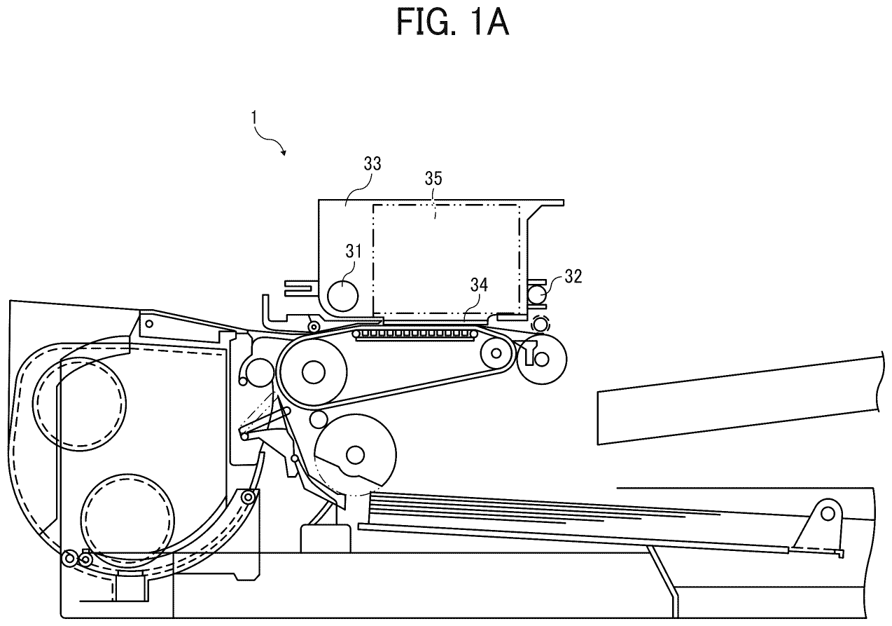

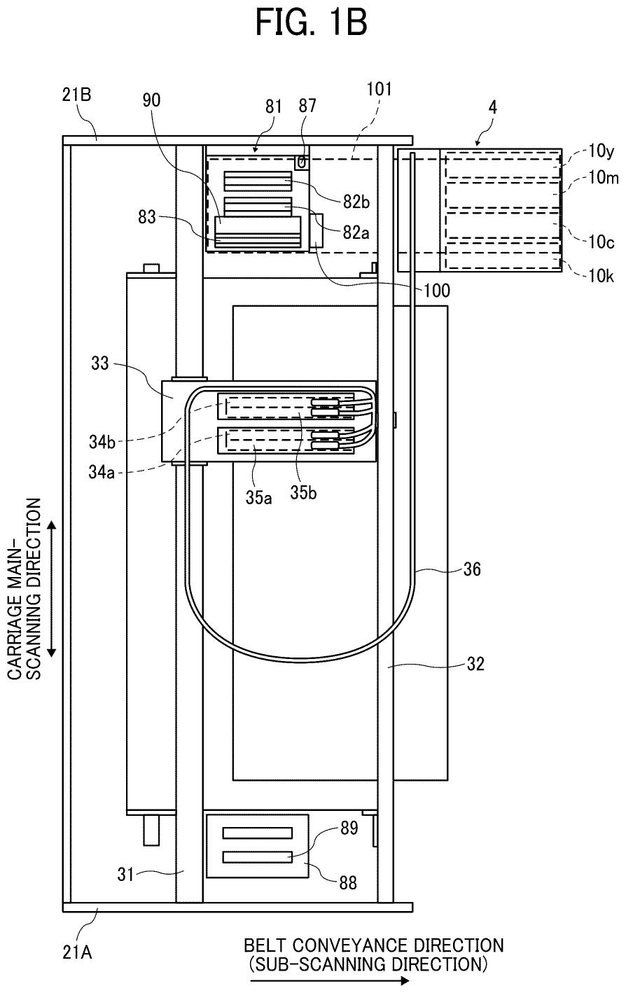

Hereinafter, as a liquid discharge apparatus according to the present embodiment, an embodiment of a serial type inkjet recording apparatus that is an image forming apparatus will be described with reference to the drawings. FIG. 1A is an explanatory view of an overall configuration of the inkjet recording apparatus according to the present embodiment as viewed from a side. FIG. 1B is an explanatory view of a main part of the inkjet recording apparatus as viewed from above.

In an inkjet recording apparatus 1 of the present embodiment, a carriage 33 is slidably held in a main-scanning direction by master-slave guide rods 31 and 32 which are guides laterally bridged on left and right side plates 21A and 21B of an apparatus body. The carriage 33 moves in a direction indicated by an arrow in FIG. 1B (carriage main-scanning direction) along the master-slave guide rods 31 and 32 via a timing belt driven by a main scanning motor.

The sliding in the present embodiment includes both a case where a slider itself comes into contact with and moves, and a case where the member does not move but another member different from the member comes into contact with and moves to relatively slide.

On the carriage 33, two recording heads 34a and 34b (referred to as “recording heads 34” when not distinguished) are mounted as liquid discharge heads for discharging ink that is liquid. The recording head 34 includes a nozzle surface having two nozzle rows with multiple nozzles arranged in a sub-scanning direction orthogonal to the main-scanning direction. The recording head 34 is mounted on the carriage 33 such that the nozzle surface faces downward, that is, an ink discharging direction from the nozzles faces downward.

In the present application, the “liquid discharge head” is a functional component that discharges and sprays liquid from nozzles. Discharged liquid is not limited to a particular liquid as long as the liquid has a viscosity or surface tension to be discharged from a head. However, preferably, the viscosity of the liquid is not greater than 30 mPa·s under ordinary temperature and ordinary pressure or by heating or cooling.

Specific examples of such liquids include, but are not limited to, solutions, suspensions, and emulsions containing solvents (e.g., water, organic solvents), colorants (e.g., dyes, pigments), functionality imparting materials (e.g., polymerizable compounds, resins, surfactants), biocompatible materials (e.g., deoxyribonucleic acid (DNA), amino acid, protein, calcium), and edible materials (e.g., natural colorants). Such liquids can be used as inkjet inks, surface treatment liquids, liquids for forming compositional elements of electric or luminous elements or electronic circuit resist patterns, and three-dimensional object forming material liquids. Examples of an energy source to generate energy to discharge liquid include a piezoelectric actuator (a laminated piezoelectric element or a thin-film piezoelectric element), a thermal actuator that employs a thermoelectric conversion element, such as a heating resistor, and an electrostatic actuator including a diaphragm and opposed electrodes.

On the carriage 33, sub tanks 35a and 35b (referred to as “sub tanks 35” when not distinguished) are mounted for supplying ink of each color corresponding to each nozzle row of the recording head 34.

The ink of each color is replenished and fed from an ink cartridge of each color detachably attached to a cartridge loading unit 4, to the sub tank 35 through a supply tube 36 of each color by a supply pump unit.

### Maintenance Recovery Mechanism

As illustrated in FIG. 1B, a maintenance recovery mechanism 81 which maintains and recovers a state of the nozzles of the recording head 34 is arranged in a non-printing area on one side in a moving direction of the carriage 33. The maintenance recovery mechanism 81 includes: first caps 82a and 82b (referred to as “first caps 82” when not distinguished) which are cap members as a contact prevention means which covers the nozzle row of each nozzle surface of the recording head 34; a wiper 83 which is a wiping member for wiping of the nozzle surface; and a carriage lock 87 which locks the carriage 33.

As also illustrated in FIG. 1C, below the maintenance recovery mechanism 81, there is provided a collection container 100 that is not replaceable and is for storing waste liquid (ink or the like flowing down from the wiper after wiping) generated by a maintenance and recovery operation. On a side or below the maintenance recovery mechanism 81, a replaceable waste liquid tank 101 is provided.

In performing maintenance and recovery of the nozzles of the recording head 34, the carriage 33 is moved to a position facing the maintenance recovery mechanism 81, which is a home position, and the maintenance and recovery operation is performed, such as nozzle suction for suctioning from the nozzles by performing capping with the first cap 82 and dummy discharge for discharging droplets not contributing to image formation, whereby image formation with stable droplet discharge can be performed.

As illustrated in FIG. 1B, a non-printing area on another side in the moving direction of the carriage 33 is provided with a dummy discharge receiver 88 which receives ink at a time of dummy discharge performed during an image forming operation and the like. The dummy discharge receiver 88 includes an opening 89 corresponding to the nozzle row of the recording head 34.

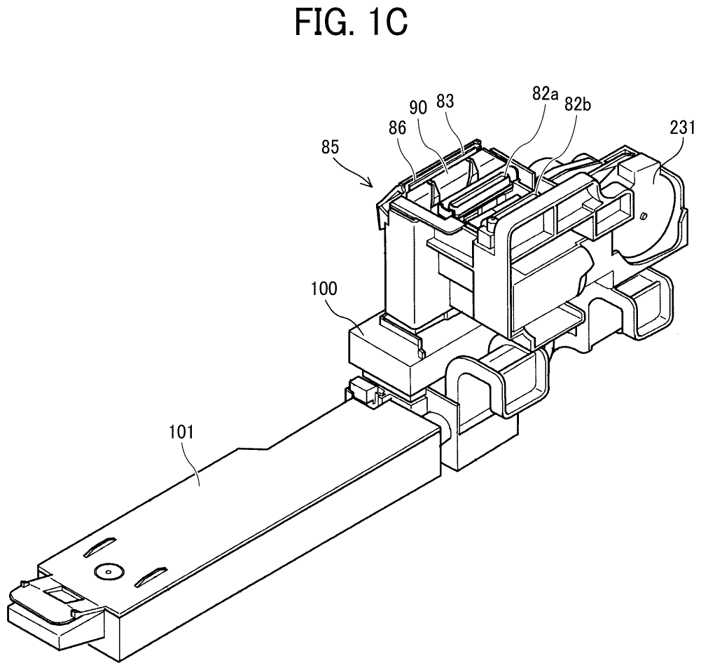

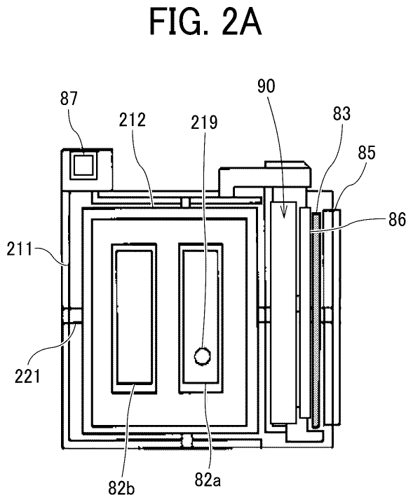

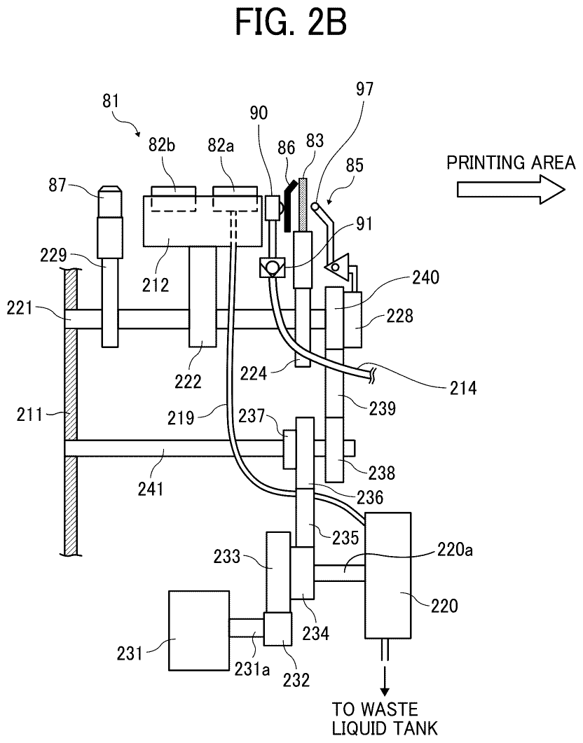

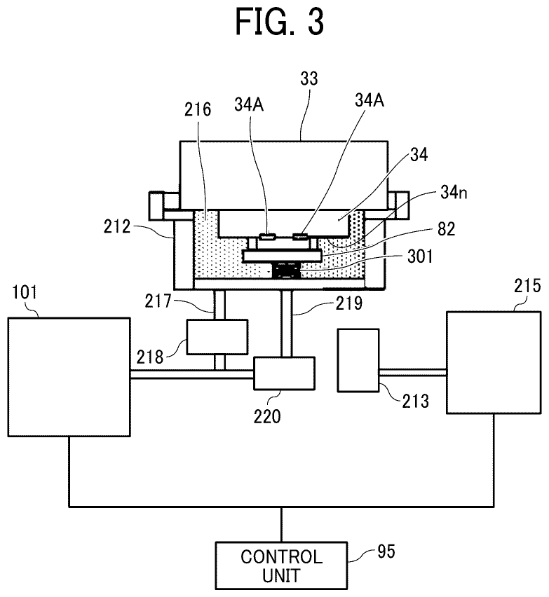

Next, the maintenance recovery mechanism 81 in the inkjet recording apparatus of the present embodiment will be described with reference to FIGS. 1C to 2B. FIG. 1C is a perspective view illustrating a part of the maintenance recovery mechanism 81. FIG. 2A is a plan view illustrating a part of the maintenance recovery mechanism 81. FIG. 2B is a schematic diagram illustrating an outline of a drive mechanism of the maintenance recovery mechanism 81. FIG. 3 is a schematic diagram illustrating an outline of a supply and ejection mechanism for a cleaning solution in the maintenance recovery mechanism 81.

In the maintenance recovery mechanism 81, a second cap 212, the wiper 83, and a slider 86 which is a wiper cleaning means (scraper) are held to be movable up and down (movable vertically) with respect to a frame 211. The first caps 82a and 82b are held by the second cap 212, and are movable up and down (movable vertically) together with the second cap 212.

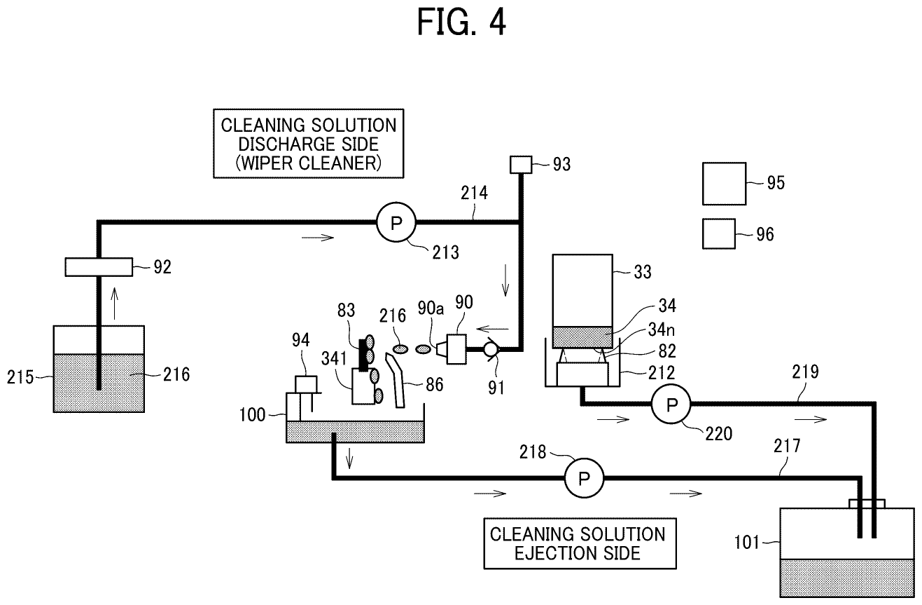

Between the wiper 83 and the first cap 82a, a cleaning solution nozzle 90 as a cleaning solution applicator and the slider 86 in FIG. 4 are arranged. The “cleaning solution applicator” may be referred to simply as an “applicator”. An upper end portion of the slider 86 on the wiper 83 side is a second wiper cleaning means which scrapes off and removes ink attached to the wiper 83. In cleaning the wiper 83, the wiper 83 is lowered in a state where the wiper 83 is pressed against the slider 86 by a wiper pressing member 85. As a result, the ink attached to the wiper 83 is scraped off by the slider 86.

A suction pump 220 as a suction means is coupled to the first cap 82a on a side close to a printing area via a flexible tube 219, and the first cap 82a is used as a cap for suction and moisture retention (hereinafter, simply referred to as “for suction”). The suction pump 220 is not coupled to the first cap 82b on a side far from the printing area, and the first cap 82b is simply used as a moisturizing cap. Therefore, in a case of performing the suction operation of the recording head 34, the recording head 34 to be a target of the suction operation is selectively moved to a position that allows capping with the first cap 82a for suction, and the head suction operation is performed.

Below the first caps 82a and 82b, the wiper 83, and the like, a camshaft 221 rotatably supported by the frame 211 is arranged. The camshaft 221 is provided with a cap cam 222 to move up and down the second cap 212, a wiper cam 224 to move up and down the wiper 83, a cleaner cam 228 to swing the wiper pressing member 85, and a carriage lock cam 229 to move up and down the carriage lock 87.

A motor gear 232 is provided on a motor shaft 231a of a motor 231, and a pump gear 233 provided on a pump shaft 220a of the suction pump 220 is arranged to mesh with the motor gear 232. A second intermediate gear 235 is arranged in mesh with a first intermediate gear 234 coaxial and integral with the pump gear 233, and a third intermediate gear 236 with a unidirectional clutch 237 is arranged in mesh with the second intermediate gear 235.

A fifth intermediate gear 239 is arranged in mesh with a fourth intermediate gear 238 which is arranged coaxially with the third intermediate gear 236 and axially rotated integrally, and a cam gear 240 secured to the camshaft 221 described above meshes with the fifth intermediate gear 239. An intermediate shaft 241 is a rotation shaft of the third intermediate gear 236 with the unidirectional clutch 237 and the fourth intermediate gear 238, and is rotatably supported by the frame 211.

In the maintenance recovery mechanism 81 of the present embodiment, in a case of removing ink and impurities attached to a surface (nozzle surface) of the recording head 34 including a nozzle 34A, first, the wiper 83 is raised via the wiper cam 224 by driving of the motor 231. In this state, by moving the carriage 33 in the printing area toward a position (non-printing area) opposed to the maintenance recovery mechanism 81, the nozzle surface of the recording head 34 is wiped by the wiper 83, and attached ink, impurities, and the like are wiped.

Furthermore, if the nozzle 34A of the recording head 34 is left in a state of being exposed to outside air, the ink inside the nozzle is dried, thickened, and adhered, and the ink discharging performance is deteriorated.

In order to prevent such a state, capping is performed with the first cap 82 to cover the nozzle 34A on the nozzle surface of the recording head 34. At this time as well, the motor 231 is driven to raise the second cap 212 via the cap cam 222, and the first cap 82 raised accordingly is brought into contact with the nozzle surface of the recording head 34, to perform capping to cover the nozzle 34A on the nozzle surface with the first cap 82.

Meanwhile, there is a case where cleaning cannot be completed by wiping alone, and unwiped portions occur to cause remaining of ink or the like on the nozzle surface. In a case where the ink or the like remains on the nozzle surface in this manner, the ink or the like adheres to the nozzle surface. When the nozzle surface with the ink adhered is again wiped by the wiper 83, the adhered ink may be peeled off from the nozzle surface, and the peeled adhered ink may be pushed into the nozzle 34A to cause ejection failure.

Furthermore, ink is likely to accumulate at a wiping end portion (nozzle surface end portion) of wiping, and the adhered ink gradually accumulates. When the adhered ink protruding from the nozzle surface due to such accumulation comes into contact with a recording sheet or the like as a liquid discharge target, recording quality (print quality) is deteriorated.

Furthermore, if ink is ejected to an adjacent recording head 34 or the like by wiping of the recording head 34 as a cleaning target, the ink drips down from the recording head 34 and stains a recording sheet or the like as the liquid discharge target. In addition, the ink stains a conveyance path on which a recording sheet or the like as the liquid discharge target is conveyed, and accordingly stains a recording sheet or the like to be conveyed later.

Thus, recording quality (print quality) is deteriorated by scattering of ink due to wiping. Furthermore, ink blown off to an adjacent recording head 34 and the like may promote ink accumulation due to wiping of the recording head 34. Furthermore, at a time of using ink having high viscosity, thickened ink attached to the wiper in the previous wiping is attached to the nozzle surface in the next head wiping, and there are disadvantages that ejection stability of the nozzle is lowered by the wiping, grime is accumulated, and the like.

Therefore, in order to efficiently clean the nozzle surface by cleaning ink grime of the wiper so as not to accumulate grime on the nozzle surface and combining with the normal nozzle surface cleaning, the liquid discharge apparatus according to the present embodiment includes a control unit that selectively controls a first operation and a second operation. The first operation is an operation in which the slider slides on a surface of the wiping member in a state where a cleaning solution is applied to the wiping member from a discharge port, and the second operation is an operation in which the wiping member wipes the nozzle surface in a state where the cleaning solution is applied to the wiping member from the discharge port.

### Supply and Discharge Mechanism for Cleaning Solution

FIG. 4 is a schematic diagram of a supply and discharge mechanism on a cleaning solution discharge side (wiper cleaner) and a cleaning solution ejection side. In the drawing, reference numeral 95 denotes a wiper cleaner control unit, and reference numeral 96 denotes a temperature and humidity sensor. The wiper cleaner control unit 95 may also be referred to simply as “control unit”. A filter 92 and a cleaning solution supply pump 213 are arranged in a cleaning solution supply tube 214 extending from a cleaning solution storage tank 215 to the cleaning solution nozzle 90.

From the cleaning solution nozzle 90, a cleaning solution 216 is sprayed toward one surface of the wiper 83. The cleaning solution 216 can enhance the wiping performance of the head nozzle surface by the wiper 83.

The cleaning solution 216 may contain a very low volatile solvent (also referred to as a wet liquid) such as glycerin or polyethylene glycol. As the solvent, a well-known organic solvent can be selected and used according to the purpose. Examples of the cleaning solution include cleaning solutions containing a solvent alone and containing water (purified water, high pure water, or the like) alone. The cleaning solution may contain various optional surfactants. By containing the surfactant, the surface tension to the nozzle surface can be adjusted, and the cleaning effect is improved. By wiping the head nozzle surface with the wiper 83 applied with the cleaning solution 216, a change in the wettability of the head nozzle surface can be prevented.

That is, the wet liquid (1) dissolves ink having increased viscosity or a filmy deposit adhered to the head nozzle surface, (2) acts as a lubricant by being interposed between the wiper 83 and the head nozzle surface, and (3) is attached to the head nozzle surface to form a protective film of the head nozzle surface.

On the downstream side of the cleaning solution supply pump 213, a check valve 91 is arranged. A discharge pressure of the cleaning solution supply pump 213 is detected by a pressure sensor 93.

A liquid level detection sensor 94 including multiple electrode pins for liquid level detection is arranged in the collection container 100 which stores waste liquid (ink or the like flowing down from the wiper after wiping) generated by the maintenance and recovery operation of the maintenance recovery mechanism 81 and the cleaning solution applied and flowing down to clean the wiper 83.

4

### Elevator of Wiper

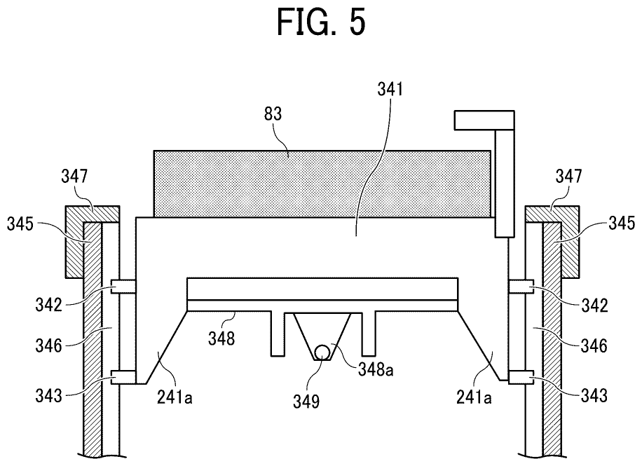

Next, an elevator (vertical movement mechanism) of the wiper 83 will be described with reference to FIG. 5. FIG. 5 is an explanatory diagram illustrating the elevator (vertical movement mechanism) of the wiper. The wiper 83 is mounted to a wiper holder 341.

At both ends of the wiper holder 341 in the sub-scanning direction, guide pins 342 and 343 are provided. The guide pins 342 and 343 are fitted into a guide groove 346 in a guide 345 (or can be the frame 211 itself) so that the wiper 83 mounted to the wiper holder 341 is vertically movable along the guide groove 346. That is, in the configuration of the present embodiment, the wiper 83 is vertically movable in a direction perpendicular to a plane including the main-scanning direction and the sub-scanning direction. The wiper 83 may be movable not only in the vertical direction but also in any direction such as a horizontal direction and an oblique direction. At an upper end portion of the guide groove 346, a stopper 347 as a regulating member to regulate rise of the guide pin 342 is provided, and a rising position of the wiper 83 is regulated.

Any arrangement and moving direction may be adopted as long as the wiper 83 and the slider 86 are at least slidable while being in contact with each other. It is preferable that one of the wiper 83 and the slider 86 is vertically movable in the perpendicular direction. That is, a relative moving direction of the wiper 83 and the slider 86 is preferably a direction perpendicular to a moving direction in which the wiper 83 wipes the nozzle surface. By relatively moving in the direction perpendicular to the moving direction in which the nozzle surface is wiped, the cleaning solution flows down according to gravity, so that the cleaning solution can be more efficiently applied, leveled, and wiped. The “perpendicular direction” is not limited to a case of being strictly 90 degrees with respect to the moving direction in which the nozzle surface is wiped, and may include some errors. Even in this case, it is a matter of course that the above effect and the effect of removing or leveling the cleaning solution 216 on the wiper 83 by the slider 86 described later can be obtained.

A flexible member 348 is mounted between both leg portions 241a and 241a of the wiper holder 341. The flexible member 348 includes a tongue piece 348a provided with a cam pin 349, and the cam pin 349 is movably fitted in a cam groove of the wiper cam 224 in FIG. 2B.

### Cleaning Sequence in Normal Cleaning

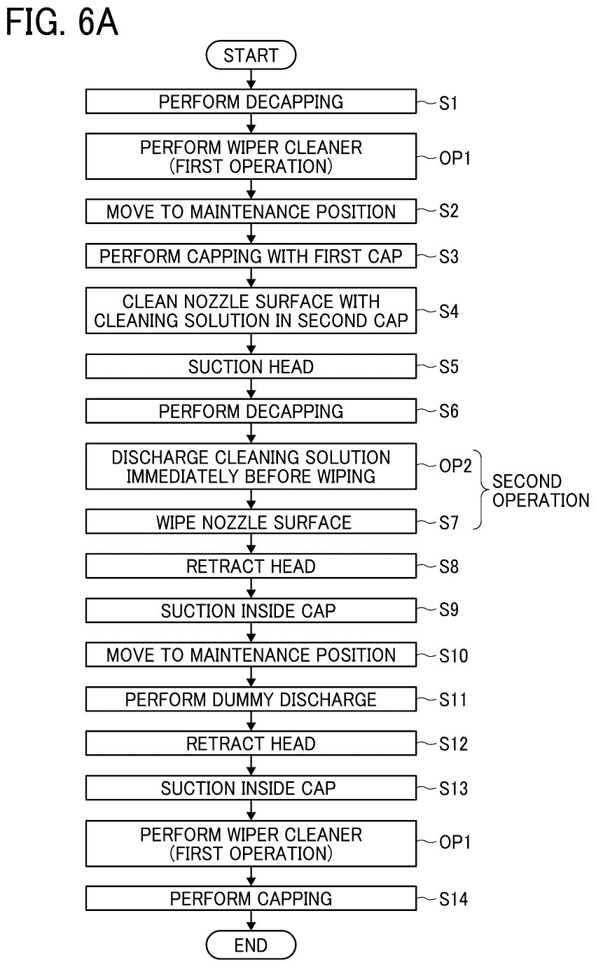

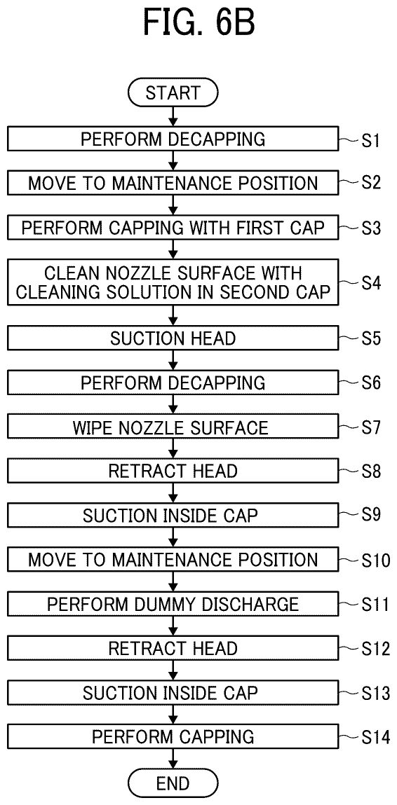

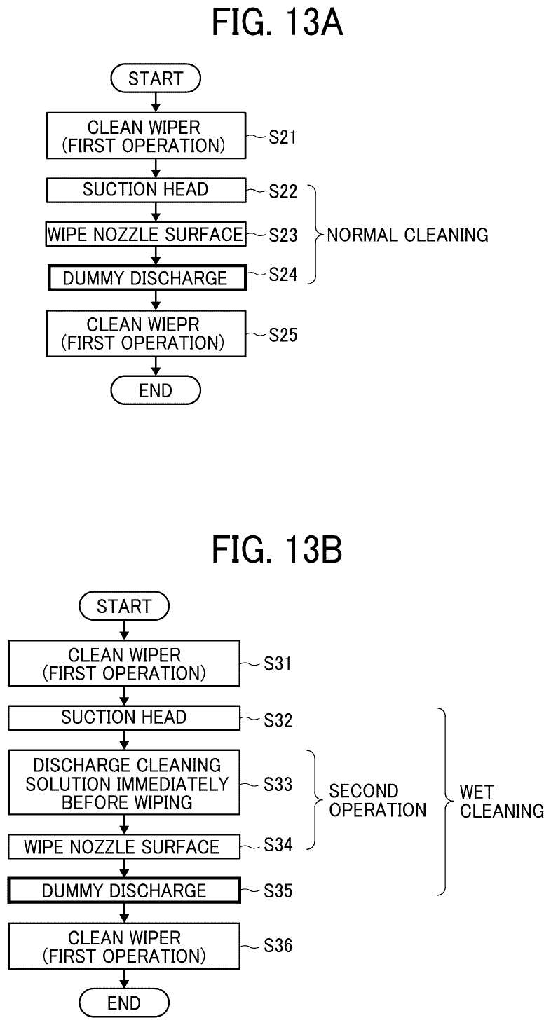

Next, a cleaning sequence in normal cleaning (FIG. 13A) which is head nozzle surface maintenance using the maintenance recovery mechanism 81 in the present embodiment will be described. FIG. 6A (first embodiment) is a flowchart illustrating a flow of a cleaning sequence in normal cleaning (FIG. 13A) in the present embodiment. This flowchart is executed by the wiper cleaner control unit 95 in FIG. 4.

When the normal cleaning is started, first, from a standby state of the inkjet recording apparatus 1, that is, a capping state in which the nozzle surface is capped by the first cap 82, the first cap 82 is removed from the nozzle surface (decapping) (S1). Subsequently, the carriage 33 is moved in the main-scanning direction to move the recording head 34 as a cleaning target to a maintenance position (position facing the first cap 82a for suction) (S2). In the first embodiment (FIG. 6A), a first operation OP1 is performed between S1 and S2.

Next, the motor 231 is driven to raise the second cap 212 via the cap cam 222. As a result, the first cap 82 rising along with the second cap 212 first comes into contact with the nozzle surface of the recording head 34, to perform capping to cover the nozzle 34A on the nozzle surface with the first cap 82 (S3).

Whereas, in order to remove foreign matters, thickened ink, bubbles, and the like in the nozzle, the suction pump 220 of the maintenance recovery mechanism 81 is driven, and a head suction operation of suctioning a certain amount of ink from the nozzle of the recording head 34 as the cleaning target is performed (S5). After the head suction operation, unnecessary ink is attached to the nozzle surface or a meniscus (liquid bridge) of the nozzle is broken Therefore, the first cap 82 is removed (S6), then the carriage 33 is moved, the nozzle surface is wiped by the wiper 83 (S7), the ink is wiped off, and the meniscus of the nozzle is formed. In the first embodiment (FIG. 6A), a cleaning solution discharge operation OP2 is performed between S6 and S7. The second operation is an operation including the cleaning solution discharge operation OP2 and S7.

Here, immediately before the end of the wiping, the wiper cam 224 of the maintenance recovery mechanism 81 is rotated to lower the wiper 83. With the cleaner cam 228 rotating at the same time, the wiper pressing member 85 presses the wiper 83 against the slider 86.

As a result, the ink attached to the wiper 83 is scraped off by the slider 86 and collected in the collection container 100. Subsequently, after the carriage 33 is moved to retract the recording head 34 as the cleaning target to the printing area side (S8), the suction pump 220 of the maintenance recovery mechanism 81 is operated again (S9), and the ink or the like remaining in the first cap 82a for suction is suctioned.

Furthermore, in a case of the recording head 34 having nozzle rows for different colors, ink of another color attached to the wiper 83 is to be mixed into the nozzle at a time of wiping. Therefore, the recording head 34 as the cleaning target is moved again to the maintenance position (position facing the first cap 82a) (S10), and the recording head 34 is driven to perform dummy discharge of the ink in the nozzle to the first cap 82a for suction (S11).

Thereafter, the carriage 33 is moved to retract the recording head 34 as the cleaning target to the printing area side (S12), and then the suction pump 220 of the maintenance recovery mechanism 81 is operated again (S13) to suction the dummy-discharged ink or the like into the first cap 82a for suction. Then, capping is performed by the first cap 82 (S14), and the cleaning is ended. In the first embodiment (FIG. 6A), the first operation OP1 is performed again between S13 and S14.

Note that there is automatic cleaning in which the cleaning sequence is automatically activated during a printing operation in order to suppress occurrence of ejection failure such as non-ejection of ink (missing print) due to entry of mist or paper dust generated during printing into a nozzle. The automatic cleaning is activated, for example, when an amount of ink (amount of consumed ink) ejected from the nozzle is cumulatively counted by soft counting after completion of cleaning, and a count value exceeds a prescribed threshold value (mainly for the purpose of preventing missing print due to mist) or when the cumulative number of printed sheets exceeds a prescribed threshold value (for the purpose of preventing missing print due to paper dust).

### First Operation and Second Operation for Improving Wiping Performance

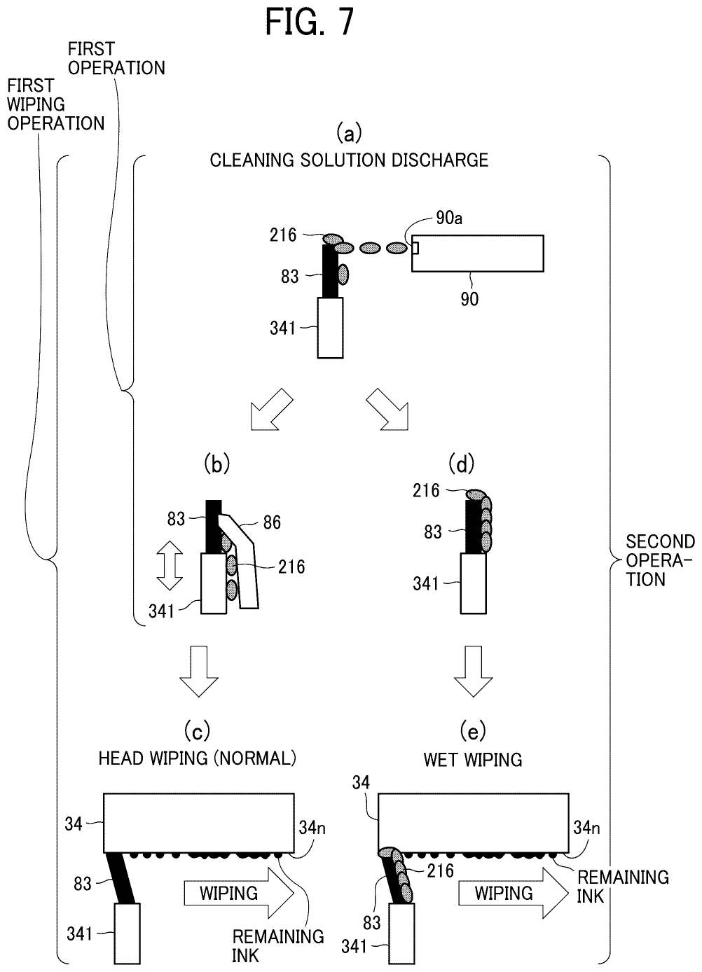

In the present embodiment, in order to improve wiping performance of the wiper 83, the following first operation is performed. First, as illustrated in FIG. 7(a), the cleaning solution 216 is applied from a discharge port 90a of the cleaning solution nozzle 90 to a distal end portion (upper portion in a height direction) of the wiper 83. As illustrated in FIG. 7(b), the slider 86 rubs the wiper 83 from the distal end portion (upper portion in the height direction) to a base end portion (lower portion in the height direction). At this time, a distal end portion of the slider 86 slides while being in contact with the surface of the wiper 83. The above operations in FIGS. 7(a) and 7(b) are referred to as the first operation. In other words, the first operation is to carry out the operation illustrated in FIG. 7(b) with the cleaning solution 216 being applied to the wiper 83 (wiping member) from the discharge port 90a.

This first operation is performed by moving the wiper 83 in the height direction by the elevator (vertical movement mechanism) of the wiper of FIG. 5. That is, when the wiper 83 is located at the lower portion in the height direction as illustrated in FIG. 7(a), the discharge port 90a of the cleaning solution nozzle 90 applies the cleaning solution 216 from the upper portion in the height direction of the wiper 83. When the wiper 83 is located in the upper portion in the height direction as illustrated in FIG. 7(b), the wiper 83 and the slider 86 come into contact with each other.

The wiper cleaner control unit 95 controls the cleaning solution nozzle 90 (applicator) to apply the cleaning solution 216 from the upper portion of the wiper 83 in the height direction when the wiper 83 is disposed at a lower portion of a moving range of the wiper 83 in the height direction, and the wiper cleaner control unit 95 controls the slider 86 to contact the wiper 83 when the wiper 83 is disposed at an upper portion of the moving range of the wiper 83 in the height direction.

This first operation can be performed once or multiple times bidirectionally from the distal end portion to the base end portion and from the base end portion to the distal end portion of the wiper 83, as necessary. This first operation enables scraping and removing, together with the cleaning solution 216, of residual ink attached to one surface of the wiper 83 at a time of the previous wiping, and thickened ink and foreign matters accumulated and solidified over time on the base end portion of the wiper 83 (improvement in cleanability of the wiper 83).

The wiper 83 thus cleaned wipes a head nozzle surface 34n of the recording head 34 as illustrated in FIG. 7(c) to wipe the remaining ink, so that the wiping performance of the head nozzle surface 34n can be improved. Hereinafter, the operation including the wiping operation of FIG. 7(c) in the above first operation is referred to as a first wiping operation. The wiping in FIG. 7(c) may be performed by scanning with the wiper 83 in the main-scanning direction while the recording head 34 is stopped, or may be performed by scanning with the recording head 34 while the wiper 83 is stopped.

Note that, a wiper (blade 301) is cleaned as in a blade cleaner 303 in FIG. 3 in Japanese Unexamined Patent Application Publication No. 2009-45802. However, the blade cleaner 303 of Japanese Unexamined Patent Application Publication No. 2009-45802 moves from an intermediate portion to a distal end portion of the wiper blade 301 to scrape off the residual ink. Therefore, it is not possible to remove thickened ink and foreign matters accumulated and solidified over time on a base end portion of the wiper blade 301.

Whereas, when the remaining ink on the head nozzle surface 34n becomes thickened ink, the wiping performance of the head nozzle surface 34n with the wiper 83 is deteriorated.

Therefore, the wiping performance may be insufficient on the thickened ink in the wiping of FIG. 7(c). Furthermore, depending on the type of ink, there is ink having high affinity with the cleaning solution.

Therefore, without rubbing the surface of the wiper 83 applied with the cleaning solution by the slider 86 as illustrated in FIGS. 7(a) to 7(d), that is, in a state where the cleaning solution is applied to the surface of the wiper 83, the wiper 83 wipes the head nozzle surface 34n of the recording head 34 to wipe the remaining ink as illustrated in FIG. 7(e). This wiping operation can be performed by moving the carriage 33 holding the recording head 34 in the main-scanning direction in the state of FIG. 7(e). Hereinafter, the series of operations in FIGS. 7(a), 7(d), and 7(e) is referred to as a second operation. In other words, the second operation is to carry out the operation of FIG. 7(e) in the state of FIG. 7(d) in which the cleaning solution is applied to the wiper 83 (wiping member) from the discharge port 90a.

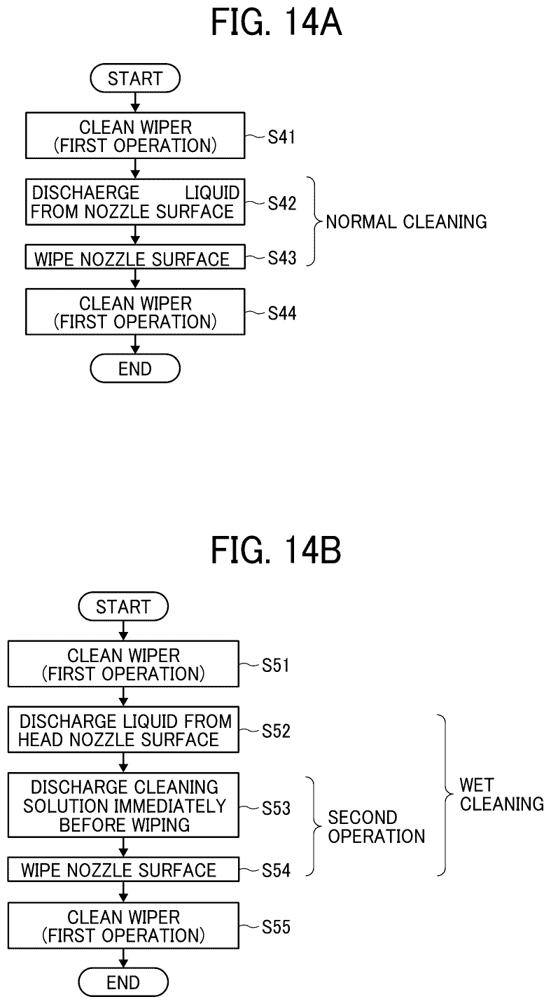

The second operation can be performed immediately before the first operation, by using the wiper cleaner control unit 95 in FIG. 4. The wiper cleaner control unit 95 can also perform the first operation, the second operation, and the first operation in this order (see FIGS. 13B and 14B).

Whether or not to interpose the second operation can be determined (selected) by the wiper cleaner control unit 95 on the basis of a detection result of the temperature and humidity sensor 96 in FIG. 4. In a case where the liquid discharge head includes the multiple recording heads 34a and 34b, the wiper cleaner control unit 95 can determine (select) whether or not to perform the second operation after the first operation for each of the multiple recording heads 34a and 34b.

In this second operation, it is not necessary to rub the surface of the wiper 83 with the slider 86. However, in a case where leveling of the cleaning solution on the surface of the wiper 83 is desired, the slider 86 may be slid with a gap between the distal end portion of the slider 86 and the surface of the wiper 83. The second operation is an operation without scraping of the cleaning solution applied to the wiper 83, and the cleaning solution applied to the wiper 83 forms a coating film on the wiper 83 with a predetermined thickness.

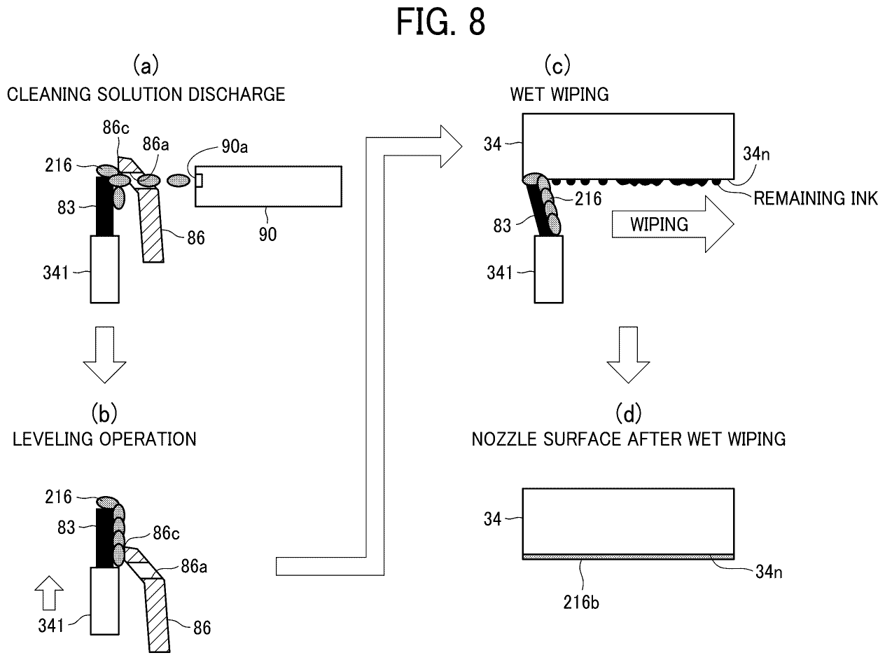

By the head wiping in the second operation, the cleaning solution applied to the wiper 83 is attached to the head nozzle surface 34n, and the liquid thickened and adhered by moisture evaporation or the like is easily dissolved, redispersed, and removed. When the cleaning solution contains a surfactant, the cleaning solution enters an interface of liquid attached to the head nozzle surface 34n, and the liquid is easily peeled off from the head nozzle surface 34n. When the head nozzle surface 34n is wiped by the wiper 83 having a cleaning solution film, the cleaning solution is transferred to the head nozzle surface 34n, and a cleaning solution protective film (coating) 216b can also be formed on the head nozzle surface 34n. (FIG. 8(d))

Therefore, even at a time of subsequent liquid discharge from the head nozzle surface 34n, liquid is less likely to be attached to the head nozzle surface 34n, and a favorable meniscus can be formed to stabilize the ink discharge. The wiping performance of the head nozzle surface 34n is also improved during the next wiping operation.

Thus, the wiping performance on thickened ink can be improved even when the thickened ink is attached to the head nozzle surface 34n. The protective film with the cleaning solution also improves head protection.

To summarize the above operations, in the present embodiment, as the wiping operation on the head nozzle surface 34n by the wiper 83, the first wiping operation of FIGS. 7(a), 7(b), and 7(c) or the second operation (second wiping operation) of FIGS. 7(a), 7(d), and 7(e) can be performed. The second operation may include a leveling operation (see FIG. 8(b)) to be described later, between FIGS. 7(d) and 7(e). The first operation illustrated in FIGS. 7(a) and 7(b) can be an operation performed as preparation for the wiping operation by the wiper 83 in FIG. 7(c). However, the first operation is not necessarily performed in combination with the subsequent wiping operation. By performing the first operation, the wiper 83 itself can be cleaned, with or without the subsequent wiping operation. A third operation (third wiping operation) to be described later can also be performed.

As described above, in the present embodiment, the wiping performance of the head nozzle surface 34n can be improved by selectively performing each operation. In particular, the wiping performance of the head nozzle surface 34n can be improved by selectively performing the first operation and the second operation. That is, in the present embodiment, the cleaning solution 216 supplied from the cleaning solution nozzle 90 can clean the wiper 83 itself in the first operation, and the wiping performance of the wiper 83 on the head nozzle surface 34n can be improved. In the second operation, the wiping performance of the wiper 83 on the head nozzle surface 34n can be improved by wiping the head nozzle surface 34n with the cleaning solution 216 covering the wiper 83. As described above, the cleaning of the wiper 83 itself by the first operation and the improvement of the wiping performance of the wiper 83 by the second operation can be achieved using the common cleaning solution nozzle 90. Therefore, in the present embodiment, for example, as compared with a configuration in which a mechanism for cleaning the wiper 83 and a mechanism for applying the cleaning solution 216 to the wiper 83 to improve the wiping performance of the wiper 83 are separately provided, it is possible to prevent the maintenance operation including the series of wiping operations from becoming longer due to complication of the process and to achieve cost reduction due to reduction in the number of parts.

The wiping in FIG. 7(e) may be performed by scanning with the wiper 83 in the main-scanning direction while the recording head 34 is stopped, or may be performed by scanning with the recording head 34 while the wiper 83 is stopped. However, in a case where the wiper 83 remains stopped as in the latter case, it is easy to maintain a state (second operation) in which the surface of the wiper 83 is covered by the cleaning solution, which is advantageous in terms of the wiping performance of the wiper 83.

In addition, by covering the surface of the wiper 83 with the cleaning solution and forming the protective film in the second operation, even if ink used by the liquid discharge head is ink that is likely to be attached and transferred to the wiper 83, the transfer and attachment of the ink to the wiper 83 can be reduced by the protective film. Furthermore, when dispersibility of the ink is high in relation to the cleaning solution, the ink can be dispersed by the cleaning solution forming the protective film at a time of the wiping operation on the nozzle surface with the wiper, and the attachment and transfer of the ink to the wiper 83 can be reduced also from this viewpoint. By reducing the transfer and attachment of the ink to the wiper 83 in this manner, the wiper 83 can be cleaned, and the wiping performance of the wiper 83 can be improved. In the second operation, due to the effect of the cleaning solution covering the wiper 83, the effect of improving separability of the ink adhered to the nozzle surface and improving the wiping performance of the nozzle surface can be obtained at the same time.

There are other cases as a case where thickened ink is attached to the head nozzle surface 34n, in addition to the case where thickened ink having poor wiping performance is used for printing. That is, in a case of using solvent ink for printing, thickened ink whose viscosity is increased by volatilization of the solvent may be attached to the head nozzle surface 34n .

Also, in a case of using ink containing an ultraviolet curable resin, thickened ink may be attached to the head nozzle surface 34n by the ink coming into contact with outside air or receiving reflected light of irradiated ultraviolet light. In this way, the wiping performance of the head nozzle surface 34n can be improved by selecting the first operation and the second operation according to an actual state of printing. The first operation and the second operation are selectively controlled by the wiper cleaner control unit 95.

The cleaning solution 216 during the second operation are desirably applied immediately before the wiping (one action before) in order to prevent dripping and drying of the cleaning solution film. The wet wiping in FIG. 7(e) is desirably performed by scanning with the recording head 34 while the wiper 83 is stopped. As a result, the wet wiping can be performed in a state where the cleaning solution film is attached to the surface of the wiper 83 to the maximum extent, and the wiping performance of the wiper 83 can be improved.

### Leveling Operation in Second Operation for Improving Wiping Performance of Wiper

As illustrated in FIG. 8(a), in the cleaning solution 216 sprayed onto the surface of the wiper 83 by the cleaning solution nozzle 90, unevenness may occur in film thickness of the cleaning solution 216 as it is. Therefore, in the cleaning solution 216 applied from the discharge port 90a to the distal end portion (upper portion in the height direction) of the wiper 83 as illustrated in FIG. 8(a), the cleaning solution 216 on the surface of the wiper 83 is leveled by the slider 86 by raising the wiper 83 once as illustrated in FIG. 8(b).

Thus, the film thickness of the cleaning solution 216 on the surface of the wiper 83 can be uniformized (leveling operation). By uniformizing the film thickness, an effect of spreading the cleaning solution 216 on the wiper 83 (liquid holding effect) can also be obtained.

Thereafter, as illustrated in FIG. 8(c), the head nozzle surface 34n of the recording head 34 is wiped by one scan of the wiper 83, and the remaining ink is wiped. Thus, the wiping performance on thickened ink can be improved even when the thickened ink is attached to the head nozzle surface 34n. Further, as illustrated in FIG. 8(d), by uniformly applying the cleaning solution 216 attached to the upper portion of the wiper 83 to the head nozzle surface 34n, the cleaning solution protective film 216b can be formed on the head nozzle surface 34n, and the wiping effect can be enhanced.

The wiping in FIG. 8(c) may be performed by scanning with the wiper 83 in the main-scanning direction while the recording head 34 is stopped, or may be performed by scanning with the recording head 34 while the wiper 83 is stopped. In a case where the wiper 83 remains stopped as in the latter case, it is easy to maintain a state (second operation) in which the surface of the wiper 83 is covered with the cleaning solution with a uniform thickness (maximization of the wiper liquid film), which is advantageous for improving the wiping performance of the wiper 83.

The action of the slider 86 is preferably performed immediately after completion of the spray of the cleaning solution 216 onto the wiper 83. This is because, if the action of the slider 86 is delayed, liquid film peeling due to dripping or drying of the liquid film occurs.

Therefore, in the embodiment of FIGS. 8(a) to 8(d), a through hole 86a is formed near the distal end portion of the slider 86. The through hole 86a allows the distal end portion of the wiper 83 to be seen from the cleaning solution nozzle 90. That is, the through hole 86a is a passage area that allows the cleaning solution 216 discharged from the discharge port 90a to pass to the wiper 83 side.

Therefore, the cleaning solution 216 can be sprayed from the cleaning solution nozzle 90 to the wiper 83 through the through hole 86a. By relatively raising the wiper 83 simultaneously as illustrated in FIG. 8(b) while spraying the cleaning solution 216 from the cleaning solution nozzle 90, the leveling operation in the second operation by the slider 86 can be performed with minimized dripping and drying of the cleaning solution 216. Accordingly, the wiping performance of the head nozzle surface 34n can be improved in the wiping of FIG. 8(c). The slider 86 has a through hole 86a through which the cleaning solution 216 discharged from the discharge port 90a is passable toward the wiper 83.

### Slider (Scraper) of Cleaning Solvent Passing Type

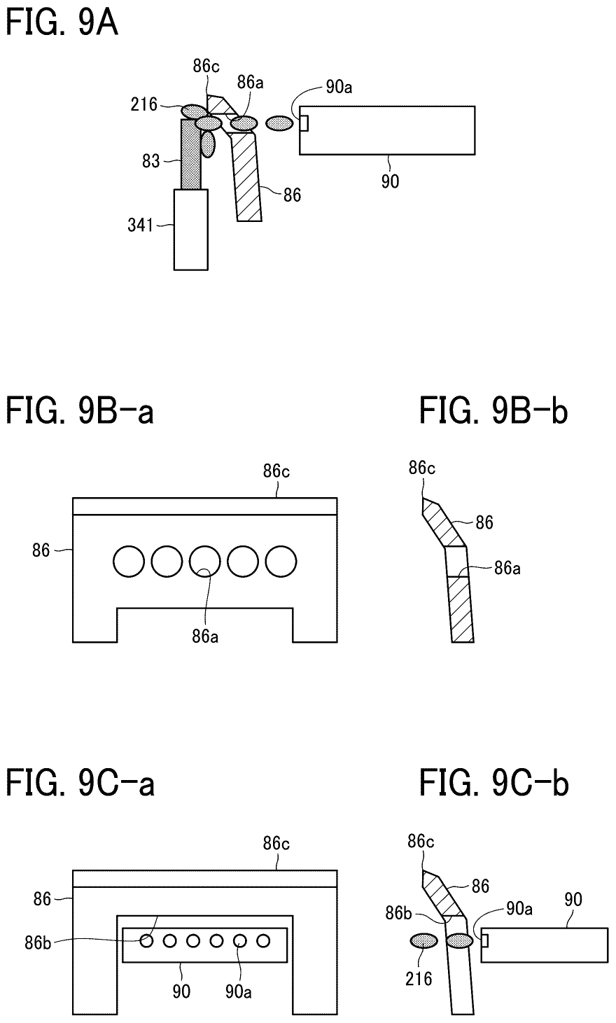

FIG. 9A, FIGS. 9B-a and 9B-b, and FIGS. 9C-a and 9C-b illustrate an example of the slider 86 of a cleaning solvent passing type suitable for the second operation. In this example, the cleaning solution 216 discharged from the discharge port 90a of the cleaning solution nozzle 90 is applied to the wiper 83 without being attached to the slider 86.

The discharge port 90a of the cleaning solution nozzle 90 and the upper portion of the wiper 83 are on substantially the same horizontal line. The slider 86 is located between the cleaning solution nozzle 90 and the wiper 83. The through hole 86a as a passage area is at a position where an upper portion of the slider 86 intersects a straight line connecting the discharge port 90a of the cleaning solution nozzle 90 and the upper portion of the wiper 83.

A scraping portion 86c bent toward the wiper 83 is at an upper end portion of the slider 86. The scraping portion 86c is at a position close to the wiper 83. By a wiper drive source raising the wiper 83 having the cleaning solution 216 applied to the upper portion of the wiper 83, the scraping portion 86c of the wiper 83 performs scraping.

The through hole 86a in the slider 86 in FIG. 9A can be formed by multiple round holes or in a horizontally long slit shape. In a case where the through hole 86a is formed by multiple round holes as illustrated in FIGS. 9B-a and 9B-b, it is needless to say that each through hole 86a is formed on an extension line of an axis of the cleaning solution nozzle 90.

In FIGS. 9C-a and 9C-b, the wiper 83 is formed in a gate shape. The cleaning solution 216 from the cleaning solution nozzle 90 is sprayed onto the surface of the wiper 83 through an inner opening 86b as a passage area of the gate shape.

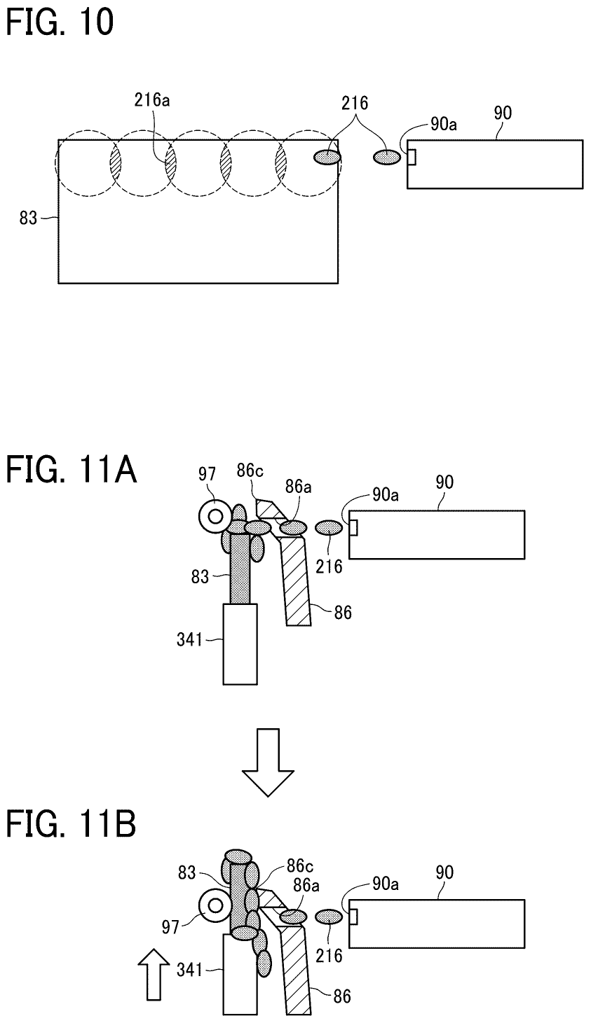

Droplets of the cleaning solution 216 sprayed from the cleaning solution nozzle 90 are desirably continuous on the surface of the wiper 83 without any gap. FIG. 10 illustrates a state where multiple droplets of the cleaning solution 216 discharged from multiple discharge ports 90a (nozzle array) arranged side by side in the cleaning solution nozzle 90 overlaps with each other at an overlapping portion 216a.

Thus, the cleaning solution nozzle 90 (applicator) includes multiple discharge ports 90a that includes the discharge ports 90a, and the wiper cleaner control unit 95 controls the cleaning solution nozzle 90 (applicator) to discharge droplets of the cleaning solution 216 from the multiple discharge ports 90a to cause the droplets to be overlapped with each other on the wiper 83.

By the droplets overlapping at the overlapping portion 216a in this way, a film thickness of the cleaning solution 216 on the surface of the wiper 83 can be uniformized without interruption. As illustrated in FIG. 10, the entire width direction area of the wiper 83 can be set as a liquid spraying range. As a result, the cleaning solution can be uniformly applied to the nozzle surface during wiping, and the wiping performance of the wiper 83 can be improved.

A discharge pressure from the cleaning solution nozzle 90 is optimized to a predetermined pressure range by controlling a drive duty of the cleaning solution supply pump 213 on the basis of a detection pressure of the pressure sensor 93 in FIG. 4. Thus, a discharge amount of the cleaning solution nozzle 90 can be adjusted, and the film thickness of the cleaning solution 216 on the surface of the wiper 83 can be optimized.

### Second Slider

On a back side of the wiper 83, that is, on a side opposite to the slider 86 and the cleaning solution nozzle 90 as viewed from the wiper 83, as illustrated in FIGS. 11A and 11B, a second slider 97 having a liquid receiving function can be arranged. The second slider 97 is referred to as “another slider”. The second slider 97 is fixedly arranged at the same height as the slider 86 and the cleaning solution nozzle 90, and corresponds to a distal end portion of the wiper pressing member 85 in FIG. 2B.

The second slider 97 can prevent the cleaning solution 216 sprayed from the cleaning solution nozzle 90 from unnecessarily going around to the back side of the wiper 83. That is, as illustrated in FIG. 11A, the cleaning solution 216 splayed from the cleaning solution nozzle 90 comes over the distal end portion of the wiper 83 while scratching and is to go around to the back side of the wiper 83.

The second slider 97 is another slider disposed on an opposite side of the slider 86 with the wiper 83 in between.

However, due to the presence of the second slider 97, it is possible to minimize an amount of the cleaning solution 216 going around to the back side of the wiper 83. Therefore, as a matter of course, the second slider 97 can reduce waste of the cleaning solution 216, and a sufficient film thickness of the cleaning solution 216 on the surface of the wiper 83 can be secured by using the cleaning solution 216 without waste. In particular, a sufficient amount of the cleaning solution 216 can be applied to the distal end portion of the wiper 83, and the wiping effect of the head nozzle surface 34n by the wiper 83 can be enhanced.

By applying the cleaning solution while moving the wiper 83 up and down in a state where a sufficient film thickness of the cleaning solution 216 is secured as described above, the wiping surface of the wiper 83 can be quickly cleaned intensively. In addition, a discharge amount of the cleaning solution 216 can be set to an amount that allows removing of grime at the base end portion of the wiper 83 and forming of the protective film.

The second slider 97 has any shape without particular limitation, but can be desirably a rotatable steel use stainless (SUS) roller. The SUS roller can reduce friction with the wiper 83, and the SUS can inhibit corrosion caused by ink and the cleaning solution 216.

### Wiping Operation

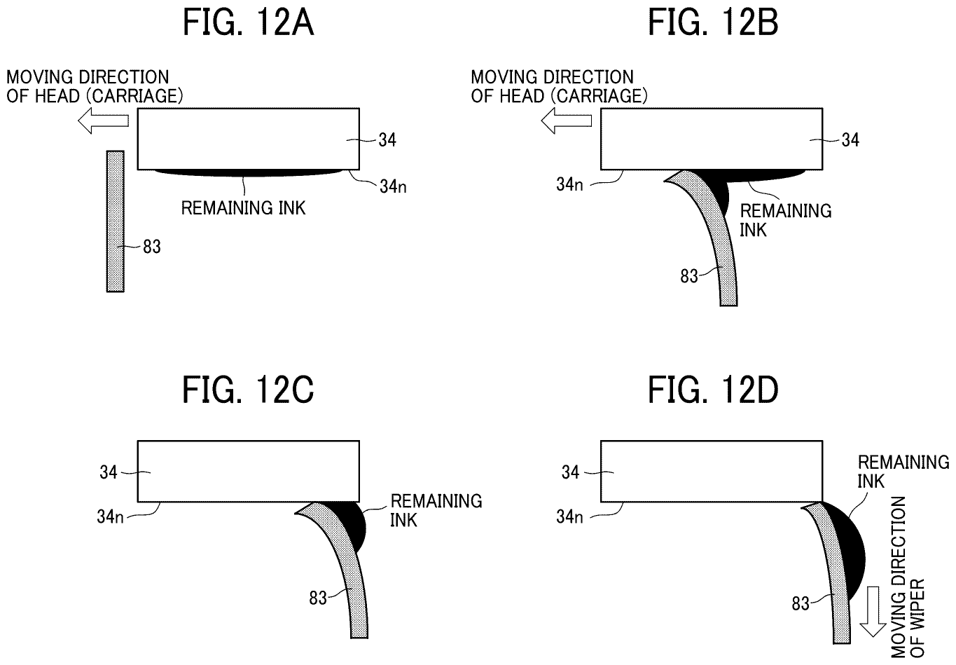

Next, a wiping operation on the head nozzle surface 34n of the recording head 34 will be described with reference to FIGS. 12A to 12D. FIGS. 12A to 12D illustrate a state of scanning with the recording head 34 in the main-scanning direction (arrow direction) while the wiper 83 is stopped.

FIG. 12A is an explanatory view illustrating a positional relationship between the recording head and the wiper before wiping. FIG. 12B is an explanatory view illustrating a positional relationship between the recording head and the wiper during wiping. FIG. 12C is an explanatory view illustrating a positional relationship between the recording head and the wiper immediately before an end of the wiping. FIG. 12D is an explanatory view illustrating a positional relationship between the recording head and the wiper at the end of wiping.

In wiping, as illustrated in FIG. 12A, the wiper 83 is caused to stand by at a position raised via the wiper cam 224 by driving of the motor 231 of the maintenance recovery mechanism 81 in advance, and then, as illustrated in FIGS. 12B and 12C, the carriage 33 is moved to wipe the head nozzle surface 34n with the wiper 83. At this time, an edge portion of the wiper 83 comes into close contact with the head nozzle surface 34n and slides, to move ink or the like attached on the head nozzle surface 34n to one side after the head suction operation. At the end of wiping, as illustrated in FIG. 12D, the wiper 83 with ink or the like attached on the head nozzle surface 34n is lowered, to remove the ink or the like from the head nozzle surface 34n.

### Flowchart (FIG. 13A)

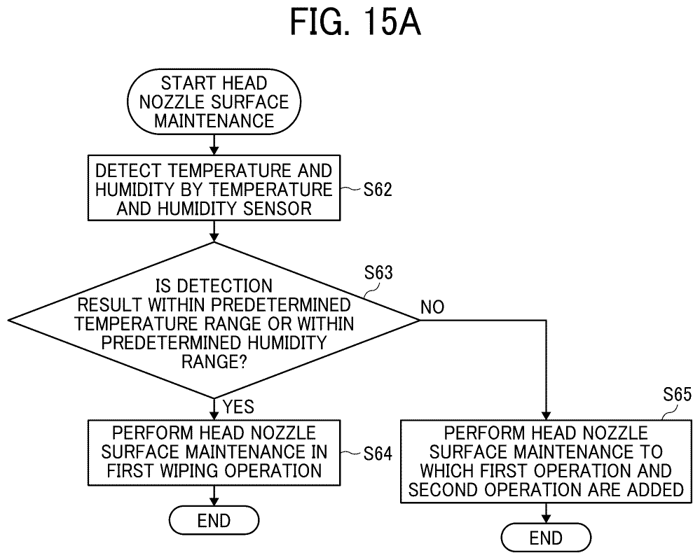

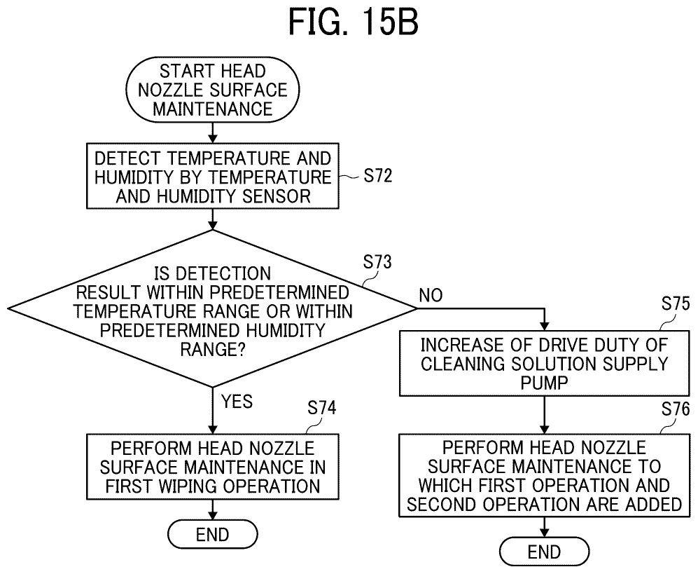

Next, maintenance of the head nozzle surface 34n will be described with reference to flowcharts of FIGS. 13A to 15B. The flowcharts in FIGS. 13A and 15B are executed by the wiper cleaner control unit 95 in FIG. 4A.

FIG. 13A illustrates head nozzle surface maintenance in the first wiping operation and the first operation. In wiper cleaner (first operation) in S21, grime and adhered ink (thickened ink) attached to the wiper 83 during standing is preliminarily removed. Thereafter, the suction operation (S22) is performed, and then wiping (S23) is performed. These steps S21 and S23 are the first wiping operation. Then, dummy discharge (S24) is performed. The suction (S22), the wiping (S23), and the dummy discharge (S24) are normal cleaning of the head nozzle surface (maintenance and recovery of the nozzles).

Finally, in wiper cleaner (S25), the wiper 83 is cleaned by the first operation. This wiper cleaner can prevent in advance a part of ink transferred to the wiper 83 from remaining as it is and later becoming adhered ink (thickened ink).

### Flowchart (FIG. 13B)

FIG. 13B illustrates head nozzle surface maintenance to which the first operation and the second operation are added. In wiper cleaner (first operation) in S31, grime and adhered ink (thickened ink) attached to the wiper 83 during standing is preliminarily removed.

Next steps S32 to S35 are wet cleaning of the head nozzle surface (maintenance and recovery of the nozzles). In this wet cleaning, in addition to normal cleaning, the cleaning solution discharge operation of FIG. 7(a) is performed immediately before wiping (S34).

Since the cleaning solution is applied to the wiper 83 cleaned in the first operation, the wiper 83 can be covered with the cleaning solution film with high purity which does not contain unnecessary foreign matters. In the wiping in S34, the wiper 83 is covered with the cleaning solution having high purity, and the wiping performance of the wiper 83 can be improved (steps S33 and S34 above are the second operation).

Finally, in wiper cleaner (S36), the wiper 83 is cleaned by the first operation. This wiper cleaner can prevent in advance a part of ink transferred to the wiper 83 from remaining as it is and later becoming adhered ink (thickened ink).

The maintenance flow of FIG. 13A and the maintenance flow of FIG. 13B can be switched by automatic control. Alternatively, the wiper cleaner control unit 95 may be controlled to allow a user to freely select the first wiping operation and the second operation.

### Flowchart (FIG. 14A)

FIG. 14A illustrates head nozzle surface maintenance in the first wiping operation and the first operation. In wiper cleaner (first operation) in S41, grime and adhered ink (thickened ink) attached to the wiper 83 during standing is preliminarily removed.

Next steps S42 and S43 are normal cleaning of the head nozzle surface (maintenance and recovery of the nozzles). In S42, liquid (blowing ink) is ejected from the head nozzle surface to prevent clogging of the nozzle. Then, ink remaining on the head nozzle surface is removed by wiping (S43). Steps S41 and S43 are the first wiping operation.

Finally, in the wiper cleaner (S25), the wiper 83 is cleaned by the first operation. This wiper cleaner can prevent in advance a part of ink transferred to the wiper 83 from remaining as it is and later becoming adhered ink (thickened ink).

### Flowchart (FIG. 14B)

FIG. 14B illustrates head nozzle surface maintenance to which the first operation and the second operation are added. In wiper cleaner (first operation) in S51, grime and adhered ink (thickened ink) attached to the wiper 83 during standing is preliminarily removed.

Next steps S52, S53, and S54 are wet cleaning of the head nozzle surface (maintenance and recovery of the nozzles). In S52, liquid (blowing ink) is ejected from the head nozzle surface to prevent clogging of the nozzle. After the surface of the wiper 83 is covered with the cleaning solution in the cleaning solution discharge operation of FIG. 7(a) (S53), ink remaining on the head nozzle surface is removed by wiping (S54) (steps S53 and S54 above are the second operation).

Finally, in the wiper cleaner (S55), the wiper 83 is cleaned by the first operation. This wiper cleaner can prevent in advance a part of ink transferred to the wiper 83 from remaining as it is and later becoming adhered ink (thickened ink).

### Flowchart (FIG. 15A)

FIGS. 15A and 15B illustrate head nozzle surface maintenance using the temperature and humidity sensor 96 of FIG. 4. That is, depending on a temperature and humidity environment of a place where the liquid discharge apparatus of the present embodiment is placed, ink on the head nozzle surface may be thickened due to a change in moisture evaporation amount or the like. Therefore, an example of a method of selecting a wiping control method on the basis of the temperature and humidity environment will be described with reference to FIGS. 15A and 15B.

Steps S61 to S64 in FIG. 15A are a flow in a case where a detection result is within a predetermined temperature range or within a predetermined humidity range. When a detection result is within the predetermined temperature range or within the predetermined humidity range, a degree of the wiping performance of the head nozzle surface is normal. Therefore, the head nozzle surface maintenance in the first wiping operation (S64) and the wiper cleaning in the first operation are performed.

In a case where a detection result of the temperature and humidity sensor 96 is out of the predetermined temperature range or out of the predetermined humidity range, the wiping performance of the head nozzle surface deteriorates. Therefore, in this case, head nozzle surface maintenance (S65) is performed to which the wiper cleaning by the first operation and the second operation are added. Thus, the head nozzle surface maintenance can be performed with an optimum use amount of a cleaning solution without unnecessarily consuming the cleaning solution.

### Flowchart (FIG. 15B)

FIG. 15B is head nozzle surface maintenance in consideration of a case where a detection result of the temperature and humidity sensor 96 greatly deviates from the predetermined range. Steps S71 to S74 in FIG. 15B are a flow in a case where a detection result is within the predetermined temperature range or within the predetermined humidity range. In a case where a detection result is within the predetermined temperature range or within the predetermined humidity range, a degree of the wiping performance of the head nozzle surface is normal. Therefore, the head nozzle surface maintenance in the first wiping operation (S74) and the wiper cleaning in the first operation are performed.

In a case where a detection result of the temperature and humidity sensor 96 greatly deviates from the predetermined range, the wiping performance of the head nozzle surface further deteriorates. Therefore, in this case, a drive duty of the cleaning solution supply pump 213 is increased, to increase a discharge pressure (S75) before performing the head nozzle surface maintenance (S76) to which the wiper cleaning by the first operation and the second operation are added.

As a result, an amount of the cleaning solution 216 sprayed from the cleaning solution nozzle 90 increases, a film thickness of the cleaning solution 216 covering the surface of the wiper 83 in the second operation can be increased, and the wiping performance of the head nozzle surface can be improved. Specifically, an amount of the cleaning solution 216 sprayed from the cleaning solution nozzle 90 is a flow rate at which the cleaning solution 216 flows to the base end portion of the wiper 83.

### Multiple Recording Heads Filled With Liquid Having Different Thickening Properties

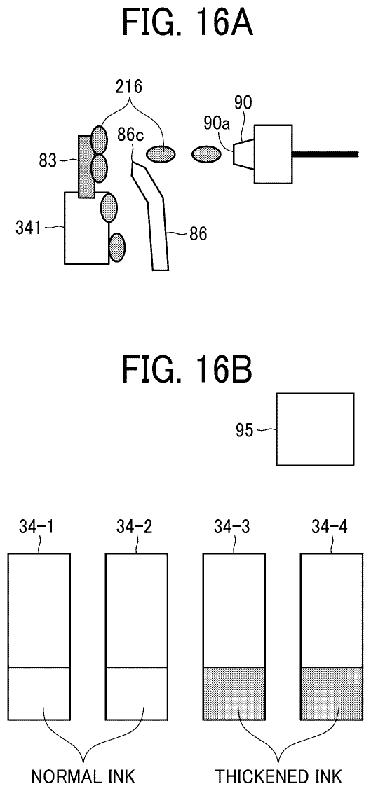

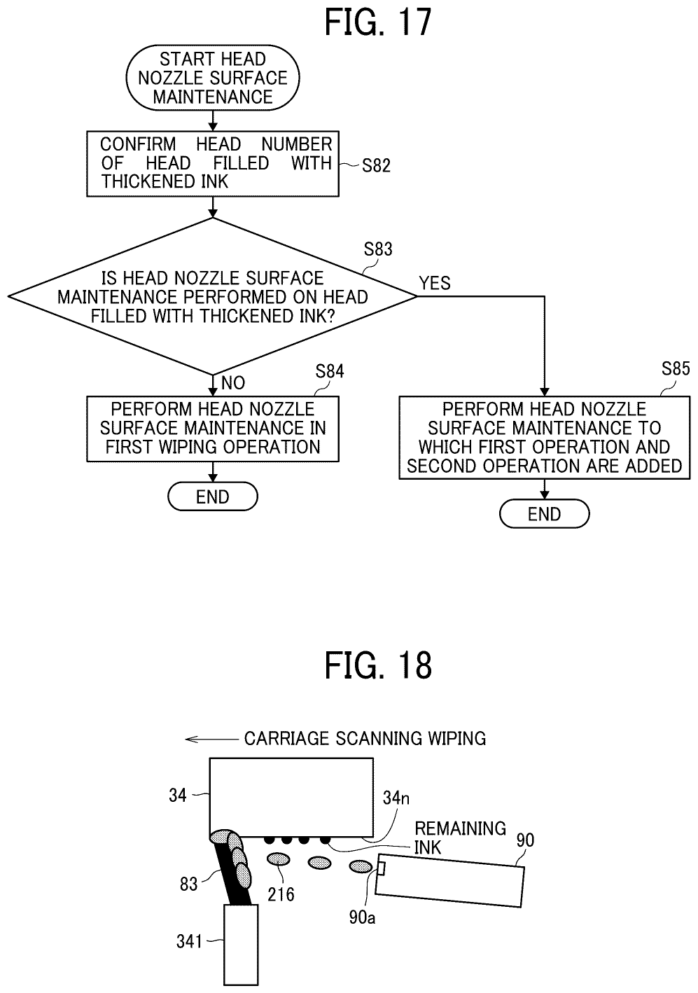

FIGS. 16A and 16B and 17 illustrate head nozzle surface maintenance of a liquid discharge apparatus including multiple recording heads 34 filled with liquid having high thickening property and multiple recording heads 34 filled with liquid having relatively low thickening property. That is, since the wiping performance of the head nozzle surface varies depending on a level of the thickening property, the wiping performance of the head nozzle surface varies depending on the recording head 34.

That is, liquid (ink) ejected from the head nozzle surface includes liquid having a high moisture evaporation rate and being likely to be thickened and adhered when exposed to air, liquid having a low moisture evaporation rate and being less likely to be thickened and adhered even when leaked into air, and the like. For example, in a case of discharging liquid that is likely to be adhered from the head nozzle surface, atomized mist may be generated separately from discharged droplets at a time of discharge, and may be attached and adhered to the head nozzle surface. Further, when the head nozzle surface is wiped with the wiper 83, the liquid that is likely to adhere may be attached and adhered to the wiper 83, and the liquid adhered to the wiper 83 may be transferred and adhered to the next wiped head nozzle surface when the next head nozzle surface is wiped.

For example, as illustrated in FIG. 16B, a recording head 34-1 and a recording head 34-2 are filled with liquid having low thickening property (normal ink), and a recording head 34-3 and a recording head 34-4 are filled with liquid having high thickening property (thickened ink). The wiping performance of the head nozzle surfaces of the recording heads 34-3 and 34-4 is worse than the wiping performance of the recording heads 34-1 and 34-2.

Therefore, the thickening property information of ink for each recording head is recorded in the wiper cleaner control unit 95. When the head nozzle surface maintenance is performed and when the maintenance of a recording head not filled with thickened ink is performed, the processes illustrated in FIG. 17 are performed.

When the head nozzle surface maintenance is performed, the ink thickening information for each recording head is recorded in the wiper cleaner control unit 95, and the head number filled with the thickened ink is confirmed (S82). Then, it is determined whether the target of the head nozzle surface maintenance is the head filled with thickened ink (S83). When the recording head not filled with the thickened ink is maintained, as illustrated in step S84 of FIG. 17, the head nozzle surface maintenance is performed in the first wiping operation illustrated in FIG. 14A and the cleaning of the wiper by the first wiping operation.

The head nozzle surface maintenance in the first wiping operation illustrated in FIG. 14A and the wiper cleaning by the first operation are performed as illustrated in step S84 of FIG. 17.

When the maintenance of a recording head filled with thickened ink is performed, the head nozzle surface maintenance is performed to which the wiper cleaning by the first wiping operation and the second wiping operation illustrated in FIG. 14B are added as illustrated in step S85 of FIG. 17.

As a result, it is possible to control whether or not to perform the second operation as necessary, and it is possible to perform head nozzle surface maintenance with an optimum use amount of a cleaning solution without consuming cleaning solution more than necessary.

### Direct Spraying of Cleaning Solution to Head Nozzle Surface (Third Operation)

FIG. 18 illustrates an embodiment in which the cleaning solution 216 is directly sprayed to the head nozzle surface of the recording head 34. That is, in applying the cleaning solution to the wiper 83, the wiper 83 is brought into contact with the head nozzle surface to eliminate a gap between the wiper 83 and the head nozzle surface.

A contact position of the wiper 83 coming into contact with the head nozzle surface 34n is a wiping start position or a position before the wiping start position as illustrated in FIG. 18. While maintaining the state of FIG. 18, the cleaning solution 216 is sprayed from the cleaning solution nozzle 90.

A landing position of the cleaning solution 216 is a contact position of the wiper 83 being in contact with the head nozzle surface 34n or a portion around the contact position. As a result, the cleaning solution 216 is reliably attached to the wiping surface of the wiper 83, and the cleaning solution 216 is also attached to the head nozzle surface 34n, which increases an applied area.

While this state is maintained, carriage scanning wiping is performed by the wiper 83. The third operation (third wiping operation) includes the cleaning solution applying operation and the wiping operation described above. The third operation enables the cleaning solution 216 to be efficiently applied to the head nozzle surface without being wastefully sprayed to the wiper 83 or a portion other than the head nozzle surface. Therefore, the wiping performance of the head nozzle surface is improved.

Depending on difficulty of wiping performance of the head nozzle surface 34n, the head nozzle surface maintenance by the wiper cleaner control unit 95 in FIG. 4 can be performed by the third operation alone, or the third operation can be performed after the first operation. The conventional liquid discharge apparatus has a configuration in which a transfer step and a wiping step of the cleaning solution are separated as in Japanese Patent No. 4708933, Japanese Unexamined Patent Application Publication No. 2007-320164, and Japanese Unexamined Patent Application Publication No. 2009-101630, so that the loss is large in time, but the configuration of FIG. 18 can reduce the loss in time.

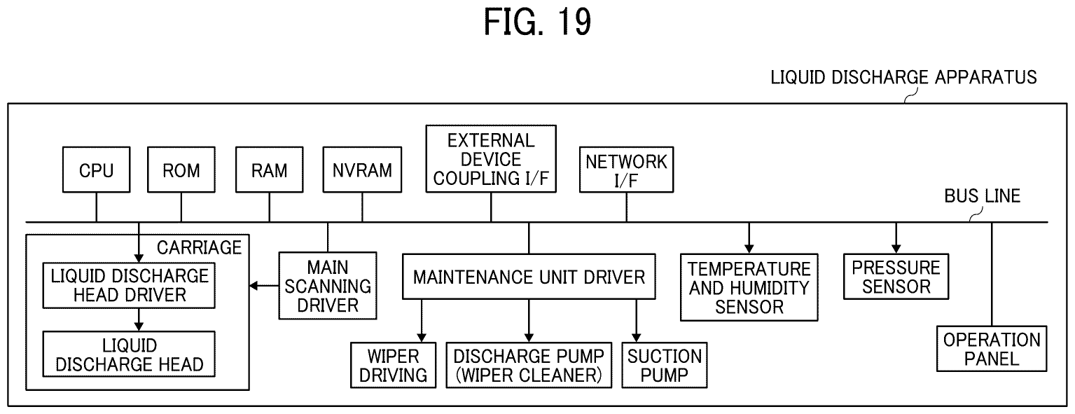

FIG. 19 is a block diagram of the liquid discharge apparatus according to the present embodiment. The first wiping operation and the second operation described with reference to FIGS. 7(a) to 7(e) and 8(a) to 8(d) and the third operation described with reference to FIG. 18 can also be manually selected by a user on an operation panel illustrated in the lower right of FIG. 19.

Although the present embodiment has been specifically described based on the embodiments, the present embodiment is not limited to the embodiments, and it goes without saying that various modifications can be made within the scope of the technical idea described in the claims.

In the present application, the “liquid discharge apparatus” is an apparatus that includes a liquid discharge head and drives the liquid discharge head to discharge liquid. The term “liquid discharge apparatus” used here includes, in addition to apparatuses to discharge liquid to a material on which liquid can be attached, apparatuses to discharge the liquid into gas (air) or liquid.

The “liquid discharge apparatus” may include means to feed, convey, and eject the material on which liquid can be attached. The liquid discharge apparatus may further include a pretreatment apparatus to coat a treatment liquid onto the material, and a post-treatment apparatus to coat a treatment liquid onto the material, onto which the liquid has been discharged.

The “liquid discharge apparatus” may be, for example, an image forming apparatus to form an image on a paper sheet by discharging ink, or a three-dimensional fabrication apparatus to discharge a fabrication liquid to a powder layer in which powder material is formed in layers to form a three-dimensional fabrication object.

The term “liquid discharge apparatus” is not limited to an apparatus to discharge liquid to visualize meaningful images, such as letters or figures. For example, the liquid discharge apparatus may be an apparatus to form meaningless images, such as meaningless patterns, or fabricate three-dimensional images.

The term “material on which liquid can be attached” above denotes, for example, a material on which the liquid can be at least temporarily attached, a material on which the liquid is attached and adhered, or a material on which the liquid is attached and into which the liquid permeates. Examples of the “material on which liquid can be attached” include recording media such as paper sheet, recording paper, recording sheet of paper, film, and cloth, electronic component such as electronic substrate and piezoelectric element, and media such as powder layer, organ model, and testing cell. The “material on which liquid can be attached” includes any material on which liquid can be attached, unless particularly limited.

Examples of the “material on which liquid can be attached” include any materials on which liquid can be attached even temporarily, such as paper, thread, fiber, fabric, leather, metal, plastic, glass, wood, ceramic, construction materials (e.g., wallpaper or floor material), and cloth textile. Examples of the “liquid” include ink, a treatment liquid, a deoxyribonucleic acid (DNA) sample, a resist, a pattern material, a binder, a shaping liquid, and a solution or a dispersion liquid containing amino acid, protein, or calcium.

The “liquid discharge apparatus” may be an apparatus to relatively move the liquid discharge head and the material on which liquid can be attached. However, the liquid discharge apparatus is not limited to such an apparatus. Specific examples include a serial type apparatus that moves the liquid discharge head, and a liquid discharge apparatus having a line-type liquid discharge head that does not move the liquid discharge head. In a case of the liquid discharge apparatus having a line-type liquid discharge head, for example, wiping operation can be performed by moving a wiping member to a position of a nozzle surface.

Examples of the liquid discharge apparatus further include: a treatment liquid applying apparatus that discharges a treatment liquid onto a paper sheet to apply the treatment liquid to the surface of the paper sheet, for reforming the surface of the paper sheet; and an injection granulation apparatus that sprays a composition liquid, in which a raw material is dispersed in a solution, through a nozzle to granulate fine particle of the raw material. The “liquid discharge apparatus” includes the liquid discharge head with functional components and mechanisms integrated, and is an assembly of components related to the liquid discharge. For example, the “liquid discharge apparatus” includes a combination of the liquid discharge head with at least one of a head tank, a carriage, a supply mechanism, a maintenance recovery mechanism, or a main scanning moving mechanism.

Examples of the “integration” include a combination in which the liquid discharge head and one or more functional components and units are secured to each other through, e.g., fastening, bonding, or engaging, and a combination in which one of the liquid discharge head and the functional components and units is movably held by another. The liquid discharge head may be detachably attached to the functional component(s) or unit(s) each other.

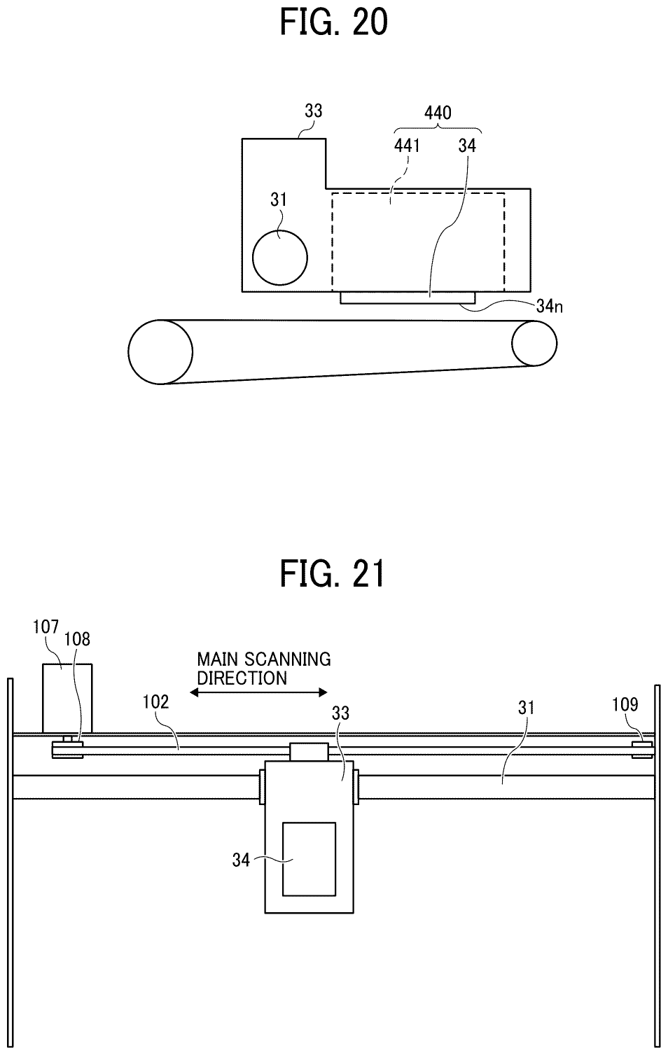

For example, as illustrated in FIG. 20, there is a liquid discharge apparatus 440 in which the recording head 34 and a head tank 441 are integrated. Further, the recording head 34 and the head tank 441 may be coupled and integrated by a tube or the like. Here, a unit including a filter may be added between the head tank 441 and the recording head 34 of these liquid discharge apparatuses.

The liquid discharge head and the carriage may be integrated to be the liquid discharge apparatus. The liquid discharge head is movably held on a guide that constitutes a part of the scanning moving mechanism. Thus, the liquid discharge head and the scanning moving mechanism may be integrated to be the liquid discharge apparatus. Furthermore, as illustrated in FIG. 21, the recording head 34, the carriage 33, and main scanning moving mechanisms 102 and 107 to 109 may be integrated to be the liquid discharge apparatus.

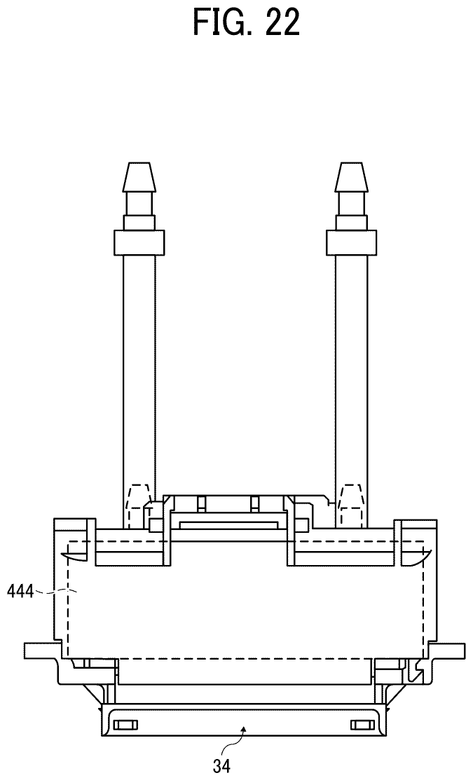

The liquid discharge apparatus has the cap member as a part of the maintenance recovery mechanism secured to the carriage with the liquid discharge head. Thus, the liquid discharge head, the carriage, and the maintenance recovery mechanism may be integrated to be the liquid discharge unit. Furthermore, as illustrated in FIG. 22, a tube may be coupled to the recording head 34 to which a head tank or a channel component 444 is mounted, and the liquid discharge head and a supply mechanism may be integrated to be the liquid discharge apparatus.

The main scanning moving mechanism may be a guide only. The supply mechanism may be a tube(s) only or a loading unit only. The terms “image formation”, “recording”, “printing”, “image printing”, and “fabricating” used herein may be used synonymously with each other.

The functionality of the elements such as the wiper cleaner control unit 95 disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

### Supplementary Note

Hereinafter, preferred aspects of the present embodiment will be additionally described.

### First Aspect

According to a first aspect, a liquid discharge apparatus includes: a liquid discharge head that discharges liquid; a wiping member that wipes a nozzle surface of the liquid discharge head; a slider that moves relative to the wiping member to slide on a surface of the wiping member; a cleaning solution applicator including a discharge port that applies a cleaning solution to the wiping member; and a control unit that selectively controls a first operation and a second operation, in which the first operation is an operation in which the slider slides on a surface of the wiping member in a state where the cleaning solution is applied to the wiping member from the discharge port, and the second operation is an operation in which the wiping member wipes the nozzle surface in a state where the cleaning solution is applied to the wiping member from the discharge port.

### Second Aspect

According to a second aspect, in the liquid discharge apparatus of the first aspect, a relative moving direction of the wiping member and the slider is a direction perpendicular to a moving direction in which the nozzle surface is wiped by the wiping member.

### Third Aspect

According to a third aspect, in the liquid discharge apparatus of the first aspect or the second aspect, the discharge port applies the cleaning solution from an upper portion of the wiping member in a height direction.

### Fourth Aspect

According to a fourth aspect, the liquid discharge apparatus of any one of the first to third aspects includes an elevator that moves the wiping member in a height direction, in which the first operation is performed by moving the wiping member in a height direction with the elevator.

### Fifth Aspect

According to a fifth aspect, the liquid discharge apparatus of any one of the first to fourth aspects includes a carriage that holds and moves the liquid discharge head, in which a wiping operation on the nozzle surface in the second operation is performed by movement of the carriage.

### Sixth Aspect

According to a sixth aspect, in the liquid discharge apparatus of any one of the first to fifth aspects, the second operation is performed immediately before the first operation.

### Seventh Aspect

According to a seventh aspect, in the liquid discharge apparatus of any one of the first to sixth aspects, in a case where the wiping member is located at a lower portion in a height direction, the discharge port applies the cleaning solution from an upper portion in a height direction of the wiping member, and in a case where the wiping member is located at an upper portion in a height direction, the wiping member and the slider are in contact with each other.

### Eighth Aspect

According to an eighth aspect, in the liquid discharge apparatus of any one of the first to seventh aspects, the slider has a passage area that allows the cleaning solution discharged from the discharge port to pass to the wiping member side.

### Ninth Aspect

According to a ninth aspect, in the liquid discharge apparatus of any one of the first to eighth aspects, the cleaning solution applicator includes multiple the discharge ports, and droplets of the cleaning solution discharged from the multiple discharge ports overlap with each other on the wiping member.

### Tenth Aspect

According to a tenth aspect, the liquid discharge apparatus of any one of the first to ninth aspects includes a second slider at the wiping member, on a side opposite to the slider.

### Eleventh Aspect

According to an eleventh aspect, in the liquid discharge apparatus of any one of the first to tenth aspects, the control unit performs control to sequentially perform the first operation, the second operation, and the first operation.

### Twelfth Aspect

According to a twelfth aspect, the liquid discharge apparatus of any one of the first to eleventh aspects includes multiple the liquid discharge heads, in which whether or not to perform the second operation after the first operation is selectable for each of the multiple liquid discharge heads.

### Thirteenth Aspect

According to a thirteenth aspect, in the liquid discharge apparatus of any one of the first to twelfth aspects, the control unit performs control to perform a third operation in which the cleaning solution is applied to the wiping member from the discharge port in a state where the wiping member is in contact with the nozzle surface, and the wiping member wipes the nozzle surface, and the control unit performs control to perform the third operation after the first operation.

Any one of the above-described operations may be performed in various other ways, for example, in an order different from the one described above.

Preferred embodiments of the present embodiment have been described above, but the present embodiment is not limited to such particular embodiments. Unless otherwise particularly limited in the above description, various modifications and alterations may be made without departing from the scope of the gist of the present embodiment in the claims.

The effects described in the embodiments of the present embodiment are merely examples of the most preferable effects generated from the present embodiment. Thus, the effects of the present embodiment are not limited to the effects described in the embodiments of the present embodiment.

The above-described embodiments are illustrative and do not limit the present invention. Thus, numerous additional modifications and variations are possible in light of the above teachings. For example, elements and/or features of different illustrative 10 embodiments may be combined with each other and/or substituted for each other within the scope of the present invention.

1. A liquid discharge apparatus comprising:
a liquid discharge head configured to discharge a liquid;
a wiper to wipe a nozzle surface of the liquid discharge head in a wiping direction;
a slider to move relative to the wiper to slide along a surface of the wiper in a sliding direction;
an applicator having a discharge port to apply a cleaning solution to the wiper; and
circuitry configured to control the wiper, slider, and the applicator to selectively perform one of a first operation and a second operation,
wherein, in the first operation, the circuitry is further configured to:
control the applicator to apply the cleaning solution to the wiper from the discharge port; and
control the slider to slide along the surface of the wiper on which the cleaning solution has been applied by the applicator in the sliding direction; and
in the second operation, the circuitry is further configured to:
control the applicator to apply the cleaning solution to the wiper from the discharge port; and
controls the wiper, on which the cleaning solution has been applied by the applicator, to wipe the nozzle surface of the liquid discharge head in the wiping direction.

2. The liquid discharge apparatus according to claim 1, wherein the sliding direction is orthogonal to the wiping direction.

3. The liquid discharge apparatus according to claim 2,
wherein the discharge port applies the cleaning solution from an upper portion to a lower portion of the wiper in a height direction of the wiper.

4. The liquid discharge apparatus according to claim 3, comprising an elevator to move the wiper in the height direction,
wherein the circuitry controls the elevator to move the wiper in the height direction to perform the first operation.

5. The liquid discharge apparatus according to claim 4, further comprising a carriage to hold and move the liquid discharge head,
wherein the circuitry moves the carriage relative to the wiper to wipe the nozzle surface in the second operation.

6. The liquid discharge apparatus according to claim 5, wherein the circuitry performs the second operation immediately before the first operation.

7. The liquid discharge apparatus according to claim 4,
wherein the circuitry controls the applicator to apply the cleaning solution from the upper portion of the wiper in the height direction when the wiper is disposed at a lower portion of a moving range of the wiper in the height direction, and
the circuitry controls the slider to contact the wiper when the wiper is disposed at an upper portion of the moving range of the wiper in the height direction.

8. The liquid discharge apparatus according to claim 1,
wherein the slider has a through hole through which the cleaning solution discharged from the discharge port is passable toward the wiper.

9. The liquid discharge apparatus according to claim 1, wherein the applicator includes multiple discharge ports includes the discharge ports, and
the circuitry controls the applicator to discharge droplets of the cleaning solution from the multiple discharge ports to cause the droplets to be overlapped with each other on the wiper.

10. The liquid discharge apparatus according to claim 1, further comprising another slider disposed on an opposite side of the slider with the wiper in between.

11. The liquid discharge apparatus according to claim 1,
wherein the circuitry sequentially performs the first operation, the second operation, and the first operation.

12. The liquid discharge apparatus according to claim 11, further comprising multiple liquid discharge heads including the liquid discharge head,
The circuitry selects whether to perform the second operation after the first operation for each of the multiple liquid discharge heads.

13. The liquid discharge apparatus according to claim 1,
wherein the circuitry is further configured to:
control the applicator to apply the cleaning solution to the wiper from the discharge port while controlling the wiper to be in contact with the nozzle surface; and
control the wiper, on which the cleaning solution has been applied, to wipe the nozzle surface to perform a third operation, and
the circuitry performs the third operation after performing the first operation.
